(19) United States
(12) Patent Application Publication
(10) Pub. No.: US 2023/0164571 A1
(43) Pub. Date: May 25, 2023

(54) Managing Sidelink Communication Security

(71) Applicant: Telefonaktiebolaget LM Ericsson (publ), Stockholm (SE)

(72) Inventors: Congchi Zhang, Shanghai (CN); Antonino Orsino, Kirkkonummi (FI); Prajwol Kumar Nakarmi, Sollentuna (SE); Noamen Ben Henda, Vällingby (SE)

(21) Appl. No.: 17/917,610

(22) PCT Filed: Apr. 8, 2021
(86) PCT No.: PCT/EP2021/059225

§ 371 Date: Oct. 7, 2022

(30) Foreign Application Priority Data
Apr. 15, 2020 (WO) PCT/EP2020/060637

(51) Int. Cl. H04W 12/69; H04W 12/06; H04W 76/14

(52) U.S. Cl. CPC H04W 12/69; H04W 12/06; H04W 76/14

(57) ABSTRACT

There is provided a method performed by a transmitting wireless device for managing sidelink communication security. A radio bearer identifier is generated (1602). The generated radio bearer identifier uniquely identifies a radio bearer for a sidelink communication between the transmitting wireless device and a receiving wireless device. The generated radio bearer identifier is transmitted (1604) to the receiving wireless device. The generated radio bearer identifier is for use in applying a security protocol to the sidelink communication. The security protocol relates to integrity/authentication and encryption of the sidelink communication. A mapping between a logic channel identifier of 6 bits and the bearer identifier of 5 bits is also disclosed.

### TECHNICAL FIELD

The disclosure relates to methods for managing sidelink communication security and entities configured to operate in accordance with those methods.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The 3^{rd} Generation Partnership Project (3GPP) specifies Long Term Evolution Device-to-Device (LTE D2D services, also known as Proximity Services (ProSe), in the Release 12 and 13 of LTE. Later, in Release 14 and 15, LTE Vehicle-to-Anything (V2X) related enhancements targeting the specific characteristics of vehicular communications are specified. The 3GPP started a new work item (WI) in August 2018, within the scope of Release 16, to develop a new radio (NR) version of V2X communications. The NR version of V2X communications mainly targets advanced V2X services, which can be categorized into four use case groups: vehicles platooning, extended sensors, advanced driving, and remote driving. The advanced V2X services require an enhanced NR system and a new NR sidelink to meet stringent requirements in terms of latency and reliability. NR V2X systems are also expected to have higher system capacity and better coverage and to allow for easy extension to support the future development of further advanced V2X services and other services.

Given the targeted services of NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in a platooning service there are certain messages that are only of interest of the member of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between user equipments (UEs) and the network (NW), including support for standalone, network-less operation.

In the 3GPP, Release 17 discussions are taking place and national security and public safety (NSPS) is considered to be one of the use cases which can benefit from the already developed NR sidelink. Therefore, it is most likely that the 3GPP will specify enhancements related to the NSPS use case taking NR Release 16 sidelink as a baseline.

FIG. 1 is a schematic illustrating NR SL unicast links between two UEs. For NR sidelink (SL), unicast at the access stratum is supported for services requiring high reliability. Between the same UE pair, there can be multiple SL unicast links and each link can support multiple SL Quality of Service (QoS) flows/radio bearers as illustrated in FIG. 1.

At the access stratum, each link can be identified by a source and destination Layer 2 identity (L2 ID). For instance, the PC5 unicast link 1 in FIG. 1 can be identified by the pair of L2 ID1 (i.e. corresponding to application ID1) and L2 ID2 (i.e. corresponding to application ID2).

FIG. 2 is a signaling diagram illustrating PC5 radio resource control (RRC) signaling to configure a SL radio bearer. For each NR SL unicast link, there can be multiple PC5 QoS flows, and one or multiple PC5 QoS flow(s) can be mapped to the same SL radio bearer. The SL radio bearer setup is done using PC5-RRC signaling as shown in FIG. 2. More specifically, with reference to FIG. 2, the initiating UE 202 sends a message (RRCReconfigurationSidelink message) 206 over PC5-RRC to the peer UE 204, including parameters related to SL radio bearer configuration and the associated PC5 QoS flow. The peer UE 204 may reply with a message (RRCReconfigurationCompleteSidelink message) 208 if the initiated SL radio bearer configuration is accepted.

TS 33.536 v1.0.0 describes security establishment during connection set-up. FIG. 3 illustrates a signaling flow of how security is established during connection set-up. That is, FIG. 3 is a signaling diagram illustrating security establishment at connection set-up. The steps illustrated in FIG. 3 will now be described.

As illustrated by arrow 302 of FIG. 3, a first UE (UE_1) sends a message (Direct Communication Request) to a second UE (UE_2). This message includes a first nonce (Nonce_1) (for generating a session key, K_{NRP-sess}), UE_1 security capabilities (the list of algorithms that UE_1 accepts for this connection), UE_1s signaling security policy and the most significant 8-bits of the K_{NRP_sess} identifier (ID). These bits are chosen such that UE_1 is able to locally identify a security context that is created by this procedure. The message may also include a key identifier (K_{NRP} ID) if the UE_1 has an existing key (K_{NRP}) for the UE that it is trying to communicate with. The absence of the K_{NRP} ID parameter indicates that UE_1 does not have a K_{NRP} for UE_2. The message also contains key establishment information (Key_Est_Info).

As illustrated by arrow 304 of FIG. 3, UE_2 may initiate a direct authorization and key establishment (Direct Auth and Key Establish) procedure with UE_1. This is mandatory if the UE_2 does not have the K_{NRP} and K_{NRP} ID pair indicated in step 302, and signaling is needed to establish the keys for the particular use case.

As illustrated by arrow 306 of FIG. 3, UE_2 sends a message (Direct Security Mode Command message) to UE_1. This message may only contain the most significant bit (MSB), optionally the Key_Est_Info of the K_{NRP} ID, and optionally the Key_Est_Info if a fresh K_{NRP} is to be generated. UE_2 includes a second nonce (Nonce_2) to allow a session key to be calculated and a parameter (Chosen_algs parameter) to indicate which security algorithms the UE uses to protect the data in the message. The Chosen-algs parameter may only indicate the use of a NULL integrity algorithm if UE_2's signaling security policy has integrity as OFF or PREFERRED. UE_2 also returns the UE_1 security capabilities and UE_1's signaling security policy to provide protection against bidding down attacks. UE_2 also includes the least significant 8-bits of the K_{NRP_sess} ID in the message. These bits are chosen so that UE_2 is able to locally identify a security context that is created by this procedure. UE_2 calculates the K_{NRP_sess} from the K_{NRP} and both Nonce_1 and Nonce_2 (see Annex X.Y of TS 33.536 v1.0.0) and then derives the confidentiality and integrity keys based on the chosen algorithms (see Annex X.Y of TS 33.536 v1.0.0). UE_2 integrity protects a command (Direct Security Mode Command) before sending it to UE_1. As illustrated by block 308 of FIG. 3, UE_2 is then ready to receive both signaling and user plane traffic protected with the new security context. UE_2 forms the K_{NRP_sess} ID from the most significant bits it received in message at step 302 and least significant bits it sent in the message at step 306.

Although not illustrated in FIG. 3, on receiving the Direct Security Mode Command, UE_1 first checks that the received least significant bit (LSB) of the K_{NPR_sess} ID is unique, i.e. has not been sent by another UE responding to this Direct Communication Request. If the LSB of the K_{NPR_sess} ID is not unique, then UE_1 responds with a Direct Security Mode Reject message including a cause value to specify that the LSB of the K_{NPR_sess} ID is not unique. The peer UE-2 receiving a Direct Security Mode Reject message inspects the cause value and, if the cause is related to the session identifier uniqueness then, UE-2 generates a new LSB of the K_{NPR_sess} ID and replies to UE-1 again (i.e., UE-2 sends a Direct Security Mode Command message with the new LSB of the K_{NPR_sess} ID). UE-2 erases the former LSB of the K_{NPR_sess} ID from its memory. On receiving this new Direct Security Mode Command, UE_1 processes the message from the start of step 310. If the LSB of the K_{NPR_sess} ID is unique, UE_1 calculates the K_{NRP_sess} and the confidentiality and integrity keys in the same way as UE_2. UE_1 checks that the returned UE_1 security capabilities and UE_1's signaling security policy are the same as those it sent in step 306. UE_1 also checks the integrity protection on the message. UE_1 may only accept the NULL integrity algorithm if its security policy for signaling indicates that integrity protection is OFF or PREFERRED. If both these checks pass, then UE_1 is ready to send and receive signaling and user plane traffic with the new security context, as illustrated by block 310 of FIG. 3. As illustrated by arrow 312 of FIG. 3, UE_1 sends a message (Direct Security Mode Complete message), which is integrity protected and confidentiality protected (with the chosen algorithm which may be the null algorithm), to UE_2. UE_1 forms the K_{NRP_sess} ID from the most significant bits it sent in the message at step 302 and the least significant bits it received in the message at step 306.

Although not illustrated in FIG. 3, UE_2 checks the integrity protection on the received Direct Security Mode Complete message. If this passes, as illustrated by block 314 of FIG. 3, UE_2 is now ready to send user plane data and control signaling protected with the new security context. As also illustrated by block 314 of FIG. 3, UE_2 deletes any old security context it has for UE_1.

The K_{NRP} may be a 256-bit root key that is shared between the two UEs (or any other entities) that communicate using PC5 NR unicast communications. It may be refreshed by re-running the authentication signaling using the long-term credentials. In order to generate a K_{NRP_sess} (the next layer of keys), nonces can be exchanged between the communicating entities. The K_{NRP} may be kept even when the UEs have no active unicast communication session between them. The K_{NRP} ID is used to identify the K_{NRP}.

TS 33.536 v1.0.0 describes security establishment during re-keying. By rekeying, the UEs ensure fresh session keys, K_{NRP-sess}, are used. Optionally, the rekeying can also enforce a refresh of the K_{NRP}. Either UE may rekey the connection at any time. This may be performed before the counter for a packet data convergence protocol (PDCP) bearer repeats with the current keys. A rekeying operation refreshes the K_{NRP_sess} and NR PC5 Encryption Key (NRPEK) and NR PC5 Integrity Key (NRPIK), and may refresh the K_{NRP}. The NRPEK and NRPIK may be used in chosen confidentiality and integrity algorithms respectively for protecting PC5-S signaling, PC5 RRC signaling, and PC5 UP traffic. They can be derived from the K_{NRP_sess}. They can be refreshed automatically every time the K_{NRP_sess} is changed. A rekeying operation follows the flows given in FIG. 4. FIG. 4 is a signaling diagram illustrating security establishment during rekeying. The steps illustrated in FIG. 4 will now be described.

As illustrated by arrow 402 of FIG. 4, a first UE (UE_1) sends a message (Direct Rekey Request) to a second UE (UE_2). This message includes a first nonce (Nonce_1) (for session key generation), UE_1 security capabilities (the list of algorithms that UE_1 accepts for this connection) and the most significant 8-bits of the K_{NRP-sess} ID. These bits are chosen such that UE_1 is able to locally identify a security context that is created by this procedure. The message may also include a reauthorization flag (Re-auth Flag) if UE_1 wants to rekey the K_{NRP}. The message also contains key establishment information (Key_Est_Info).

As illustrated by arrow 404 of FIG. 4, UE_2 may initiate a direct authorization and key establishment (Direct Auth Key Establish) procedure with UE_1. This is mandatory if UE_1 included the Re-auth Flag and signaling is needed to establish K_{NRP}.

As illustrated by arrows 406 and 408 of FIG. 4, the steps described earlier with reference to steps 306 and 308 of FIG. 3 respectively are performed, except that the chosen integrity algorithm may only be NULL if the NULL integrity algorithm is currently in use and UE_1's signaling security policy is not included in this message.

As illustrated by arrows 410 and 412 of FIG. 4, the steps described earlier with reference to steps 310 and 312 of FIG. 3 respectively are performed, except that UE_1 may only accept the NULL integrity algorithm if the NULL integrity algorithm is currently in use and UE_1 does not check the returned signaling security policy (as it is not sent in this case).

As illustrated by block 414 of FIG. 4, the step described earlier with reference to step 314 of FIG. 3 is performed. As illustrated by block 416 of FIG. 4, when UE_1 receives the message, which is integrity protected with the new security context, it deletes any old security context it still has stored for UE_2.

TS 33.536 v1.0.0 describes security establishment for user plane bearers. At initial connection or adding a V2X service, the initiating UE includes its user plane security policy in the Direct Security Mode Complete or Link Modification request message respectively. The receiving UE rejects the connection setup or Link Modification Request if the received user plane security policy had either confidentiality/integrity set to OFF and its own corresponding policy is set to REQUIRED or if the received user plane security policy had either confidentiality/integrity set to REQUIRED and its own corresponding policy is set to OFF. Otherwise, the receiving UE may accept the connection setup or Link Modification Request.

The UE initiating the establishment of a user plane bearer selects a logical channel identifier (LCID) whose associated value of bearer for input to the security algorithms has not been used with the current keys, NRPEK and NRPIK. If this is not possible the UE initiates a re-keying before establishing the user plane bearer.

When establishing the user plane bearer, the initiating UE indicates the configuration of confidentiality and integrity protection in the PC5-RRC message. The confidentiality and integrity protection algorithms are same as those selected for protecting the signaling bearers.

Both UEs ensure that the user plane for each V2X service is only sent or received (e.g. dropped if received on a bearer with incorrect security) on user plane bearers with the necessary security.

There is also the possibility of integrity protection. UEs implement the integrity algorithms NIA0, 128-NIA1 and 128-NIA2 and may implement the integrity algorithm 128-NIA3 for integrity protection of the relevant bearers. The integrity algorithms identified from TS 33.501 are reused for PC5-S, PC5-RRC, and PC5-U. These integrity algorithms are as specified in TS 33.501 and are used with the following modifications:
The key used is NRPIK;
Direction is set to 1 for direct link signaling transmitted by the UE that sent the Direct Security Mode Command for this security context and 0 otherwise;
Bearer[0] to Bearer[4] are set based on the LCID;
COUNT[0] to COUNT[31] are filled with counter value.

The receiving UE ensures that received protected signaling messages and user plane traffic that is integrity protected are not replayed.

There is also the possibility of confidentiality protection. UEs implement the ciphering algorithms NEA0, 128-NEA1 and 128-NEA2 and may implement the ciphering algorithm 128-NEA3 for ciphering of one-to-one traffic. The ciphering algorithm identifiers from TS 33.501 are reused for PC5-S, PC5-RRC, and PC5-U. These ciphering algorithms are as specified in TS 33.501 and are used with the following modifications:
The key used in NRPEK;
Direction is set as for integrity protection;
Bearer[0] to Bearer[4] are set based on the LCID;
COUNT[0] to COUNT[31] are filled with counter value.

However, there exist certain challenge(s) with the above-described existing techniques.

### SUMMARY

As mentioned earlier, there exist certain challenge(s) with the above-described existing techniques. Currently, to support the security for SL radio bearer, the UE uses a 5-bit Bearer ID (i.e., Bearer[0] to Bearer[4]) as input to the security algorithm. The 5-bit Bearer ID is set based on the LCID. Given that the SL LCID is of 6-bit, it is then an open issue how 6-bit SL LCID can be mapped to 5-bit Bearer ID used for the integrity/ciphering algorithms.

One way under discussion is that the both the sender and the receiver UEs set the 5-bit Bearer ID to be the same as the truncated bits of the SL LCID, either the most significant bits or the least significant bits. However, this may cause problems in the future when the truncated or skipped bit(s) need to be used. In that case, the hardcoded behavior of UEs to always truncate 6-bits into 5-bits may create severe limitations because of security. Also, multiple values may result in the same 5-bits, which disadvantageously increases the chances of security key reuse.

Certain aspects of the present disclosure and their embodiments may provide solutions to these or other challenges. The present invention discloses approaches to exchange parameters related to SL unicast security setup. There are, proposed herein, various embodiments which address one or more of the issues disclosed herein. Certain embodiments may provide one or more of the following technical advantage(s). These technical advantage(s) may include enabling security for sidelink communication and/or reducing (or eliminating) the risk of key reuse.

According to an aspect of the disclosure, there is provided a method performed by a transmitting wireless device for managing sidelink communication security. The method comprises generating a radio bearer identifier. The generated radio bearer identifier uniquely identifies a radio bearer for a sidelink communication between the transmitting wireless device and a receiving wireless device. The method also comprises transmitting the generated radio bearer identifier to the receiving wireless device. The generated radio bearer identifier is for use in applying a security protocol to the sidelink communication.

According to another aspect of the disclosure, there is provided a method performed by a receiving wireless device for managing sidelink communication security. The method comprises receiving a radio bearer identifier from a transmitting wireless device. The radio bearer identifier uniquely identifies a radio bearer for a sidelink communication between the transmitting wireless device and the receiving wireless device. The radio bearer identifier is for use in applying a security protocol to the sidelink communication.

According to another aspect of the disclosure, there is provided a method performed by a first wireless device for managing sidelink communication security. The method comprises selecting a first parameter and a second parameter for use in applying a security protocol to a sidelink communication between the first wireless device and a second wireless device.

According to another aspect of the disclosure, there is provided a method performed by a base station serving a transmitting wireless device for generation of a mapping between identifiers. The method comprises generating a mapping between a radio bearer identifier and a logical channel identifier. The radio bearer identifier uniquely identifies a radio bearer for a sidelink communication between the transmitting wireless device and a receiving wireless device. The logical channel identifier uniquely identifies a logical channel for the sidelink communication. The method also comprises transmitting the generated mapping to the transmitting wireless device.

According to another aspect of the disclosure, there is provided a wireless device for managing sidelink communication security. The wireless device comprises processing circuitry configured to perform any of the steps described earlier with respect to a wireless device. The wireless device comprises power supply circuitry configured to supply power to the wireless device.

According to another aspect of the disclosure, there is provided a base station for generation of a mapping between identifiers. The base station comprises processing circuitry configured to perform any of the steps described earlier with respect to a base station. The base station comprises power supply circuitry configured to supply power to the base station.

According to another aspect of the disclosure, there is provided a computer program comprising instructions which, when executed by processing circuitry, cause the processing circuitry to perform any of the steps described earlier.

According to another aspect of the disclosure, there is provided a computer program product, embodied on a non-transitory machine-readable medium, comprising instructions which are executable by processing circuitry to cause the processing circuitry to perform any of the steps described earlier.

Thus, the present disclosure provides advantageous techniques for managing sidelink communication security and for the generation of a mapping between identifiers in relation to such a sidelink communication.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic illustrating NR SL unicast links between two UEs;

FIG. 2 is a signaling diagram illustrating PC5 RRC signaling to configure an SL radio bearer;

FIG. 3 is a signaling diagram illustrating security establishment at connection set-up;

FIG. 4 is a signaling diagram illustrating security establishment during rekeying;

FIG. 5 is a schematic illustrating a ciphering of data;

FIG. 6 is a schematic illustrating a derivation of an authentication code;

FIG. 7 is a schematic illustrating a wireless network in accordance with some embodiments;

FIG. 8 is a schematic illustrating a UE in accordance with some embodiments;

FIG. 9 is a schematic illustrating a virtualization environment in accordance with some embodiments;

FIG. 10 is a schematic illustrating a telecommunication network connected via an intermediate network to a host computer in accordance with some embodiments;

FIG. 11 is a schematic illustrating a host computer communicating via a base station with a user equipment over a partially wireless connection in accordance with some embodiments;

FIG. 12 is a flowchart illustrating a method implemented in a communication system in accordance with some embodiments;

FIG. 13 is a flowchart illustrating a method implemented in a communication system in accordance with some embodiments;

FIG. 14 is a flowchart illustrating a method implemented in a communication system in accordance with some embodiments;

FIG. 15 is a flowchart illustrating a method implemented in a communication system in accordance with some embodiments;

FIG. 16 is a schematic illustrating a method performed by a transmitting wireless device in accordance with some embodiments;

FIG. 17 is a block diagram of an apparatus in a wireless network in accordance with some embodiments;

FIG. 18 is a schematic illustrating a method performed by a receiving wireless device in accordance with some embodiments;

FIG. 19 is a block diagram of an apparatus in a wireless network in accordance with some embodiments;

FIG. 20 is a schematic illustrating a method performed by a first wireless device in accordance with some embodiments;

FIG. 21 is a block diagram of an apparatus in a wireless network in accordance with some embodiments;

FIG. 22 is a schematic illustrating a method performed by a base station in accordance with some embodiments; and

FIG. 23 is a block diagram of an apparatus in a wireless network in accordance with some embodiments.

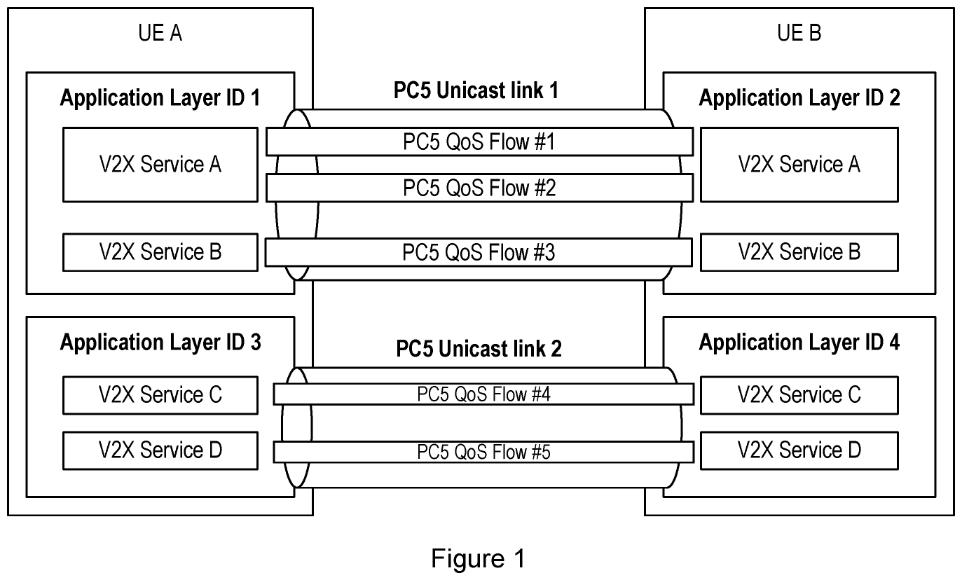

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The disclosure relates to managing sidelink communication security and also to generating a mapping between identifiers in relation to such a sidelink communication. A sidelink communication is a direct communication between wireless devices. The communication is direct in that it does not need to traverse a base station. The communication can be referred to as device-to-device communication. Herein, a sidelink communication is described with reference to a transmitting wireless device and a receiving wireless device. However, it will be understood that any two or more wireless devices may support a sidelink communication. The wireless devices involved in a sidelink communication can be proximal (or in close proximity) to each other, such as within a predefined distance of each other. A service provided by means of a sidelink communication is referred to in the art as a Proximity Service (or ProSe). A wireless device that supports a sidelink communication is referred to in the art as a ProSe-enabled wireless device.

According to an aspect of the disclosure, there is provided a first method performed by a transmitting wireless device for managing sidelink communication security. The first method comprises generating a radio bearer identifier (Bearer ID). The generated radio bearer identifier uniquely identifies a radio bearer for a sidelink communication between the transmitting wireless device and a receiving wireless device. The first method also comprises transmitting the generated bearer identifier to the receiving wireless device. The generated bearer identifier is for use in applying a security protocol to the sidelink communication. Herein, the radio bearer for a sidelink communication may also be referred to as a sidelink (SL) radio bearer. The security protocol referred to herein can, for example, be an integrity and/or ciphering protocol (or algorithm). A person skilled in the art will be aware of a variety of such security protocols that can be used, such as any of those described in TS 33.501.

In some embodiments, the radio bearer identifier may be generated in response to initiation of the radio bearer. In some embodiments, the generated radio bearer identifier may be mapped to a logical channel identifier (LCID) and the LCID may uniquely identify a logical channel for the sidelink communication.

In some embodiments, the first method may comprise acquiring the mapping of the generated radio bearer identifier to the LCID. In some embodiments, the mapping may be acquired in response to initiation of the radio bearer. In some embodiments, acquiring the mapping can comprise generating the mapping, receiving the mapping from a base station serving the transmitting wireless device, or retrieving the mapping from a memory in the transmitting wireless device.

In some embodiments where the mapping is received from a base station serving the transmitting wireless device, the mapping may be received from the base station as part of a plurality of mappings of radio bearer identities to respective LCIDs. In these embodiments, the first method may comprise selecting the mapping of the generated radio bearer identifier to the LCID from the plurality of mappings. In some embodiments, the mapping may be received from the base station via a request to establish the sidelink communication or via a message broadcast by the base station to the transmitting wireless device.

In some embodiments where the mapping is retrieved from a memory in the transmitting wireless device, the memory may comprise a plurality of mappings of radio bearer identities to respective LCIDs. In some of these embodiments, the first method may comprise selecting the mapping of the generated radio bearer identifier to the LCID from the plurality of mappings. In some embodiments, the memory can be a subscriber identity module (SIM) card or any other type of memory.

In some embodiments, the first method may comprise storing, in a memory of the transmitting wireless device, the generated radio bearer identifier and the mapping. In some embodiments, the method may comprise transmitting, to the receiving wireless device, the mapping and/or a mapping identifier that uniquely identifies the mapping. In some embodiments, transmitting the generated bearer identifier to the receiving wireless device may comprise transmitting, to the receiving wireless device, a request to establish the sidelink communication and the request may comprise the generated bearer identifier.

In some embodiments, the first method may comprise applying the security protocol to the sidelink communication using the generated bearer identifier. In some embodiments, applying the security protocol to the sidelink communication using the generated bearer identifier can comprise authenticating the sidelink communication using the generated bearer identifier or encrypting the sidelink communication using the generated bearer identifier.

According to another aspect of the disclosure, there is provided a second method performed by a receiving wireless device for managing sidelink communication security. The second method comprises receiving a bearer identifier from a transmitting wireless device. The radio bearer identifier uniquely identifies a radio bearer for a sidelink communication between the transmitting wireless device and the receiving wireless device. The bearer identifier is for use in applying a security protocol to the sidelink communication.

In some embodiments, receiving the bearer identifier may comprise receiving a request to establish the sidelink communication and the request comprises the bearer identifier. In some embodiments, the received radio bearer identifier may be mapped to a logical channel identifier (LCID) and the LCID may uniquely identify a logical channel for the sidelink communication.

In some embodiments, the second method may comprise acquiring the mapping of the received radio bearer identifier to the LCID. In some of these embodiments, acquiring the mapping may comprise receiving the mapping from the transmitting wireless device, receiving the mapping from a base station serving the receiving wireless device, or retrieving the mapping from a memory in the receiving wireless device. In some embodiments, the mapping may be received from the base station via a request to establish the sidelink communication or via a message broadcast by the base station to the receiving wireless device. In some embodiments, the mapping may be acquired in response to initiation of the radio bearer.

In some embodiments where the mapping is received from the transmitting wireless device or the base station, the mapping may be received from the transmitting wireless device or the base station as part of a plurality of mappings of radio bearer identities to respective LCIDs. In some of these embodiments, the second method may comprise selecting the mapping of the received radio bearer identifier to the LCID from the plurality of mappings. In some embodiments where the mapping is retrieved from a memory, the memory may comprise a plurality of mappings of radio bearer identities to respective LCIDs. In these embodiments, the second method may comprise selecting the mapping of the received radio bearer identifier to the LCID from the plurality of mappings. In some embodiments, the memory may be a SIM card.

In some embodiments, the second method may comprise receiving, from the transmitting wireless device, a mapping identifier that uniquely identifies the mapping. In some of these embodiments, the mapping of the received radio bearer identifier to the LCID may be selected from the plurality of mappings using the received mapping identifier. In some embodiments, the second method may comprise, if the receiving wireless device is already configured to use a different mapping, reconfiguring the receiving wireless device to use the received mapping instead. In some embodiments, the second method may comprise, if the receiving wireless device is already configured to use a different mapping, rejecting the received mapping and transmitting the different mapping to the transmitting wireless device. In some embodiments, the second method may comprise, if the receiving wireless device is not already configured to use a mapping, configuring the receiving wireless device to use the received mapping.

In some embodiments, the second method may comprise informing a base station serving the receiving wireless device that the receiving wireless device is configured to use the received mapping. In some embodiments, the second method may comprise storing, in a memory of the receiving wireless device, the received radio bearer identifier and the mapping.

In some embodiments, the second method may comprise applying the security protocol to the sidelink communication using the received bearer identifier. In some of these embodiments, applying the security protocol to the sidelink communication using the received bearer identifier may comprise authenticating the sidelink communication using the received bearer identifier or encrypting the sidelink communication using the received bearer identifier.

According to another aspect of the disclosure, there is provided a third method performed by a first wireless device for managing sidelink communication security. The third method comprises selecting a first parameter and a second parameter for use in applying a security protocol to a sidelink communication between the first wireless device and a second wireless device. The first wireless device can be the transmitting wireless device, the receiving wireless device, or any other wireless device. The second wireless device may be the receiving wireless device (in embodiments where the first wireless device is the transmitting wireless device), the transmitting wireless device (in embodiments where the first wireless device is the receiving wireless device), or any other wireless device.

In some embodiments, the first parameter and second parameter may be previously unused together in the application of a security protocol to a sidelink communication between the first wireless device and the second wireless device. In some embodiments, the second parameter may be a cryptographic key. In some embodiments, the first parameter may be a radio bearer identifier (Bearer ID). In some of these embodiments, the radio bearer identifier may uniquely identify a radio bearer for the sidelink communication.

In some embodiments, the radio bearer identifier may be mapped to a logical channel identifier (LCID). In these embodiments, the LCID may uniquely identify a logical channel for the sidelink communication. In some embodiments, the radio bearer identifier may be selected as a first of two parts of the LCID.

In some embodiments, the third method may comprise selecting a third parameter for use in applying the security protocol to the sidelink communication. In some of these embodiments, the third parameter may be selected as a second of the two parts of the LCID. In some embodiments, the third parameter may comprise one or more bits of a counter. In some embodiments, the third parameter may comprise the most significant bit (MSB) of the counter.

In some embodiments, the third method may comprise initiating a refresh procedure to refresh the second parameter such that the selected second parameter is previously unused in the application of a security protocol to a sidelink communication between the first wireless device and the second wireless device. In some embodiments, the second parameter may be mapped to one or more bits of a counter. In some embodiments, the second parameter may comprise the MSB of the counter. In some embodiments, the first parameter may be a first of two parts of a logical channel identifier (LCID) and the second parameter may be a second of the two parts of the LCID. In some of these embodiments, the LCID may uniquely identify a logical channel for the sidelink communication. In some embodiments, the first parameter may be mapped to a radio bearer identifier (Bearer ID). In these embodiments, the radio bearer identifier may uniquely identify a radio bearer for the sidelink communication.

In some embodiments, the third method may comprise applying the security protocol to the sidelink communication using the selected first parameter and the selected second parameter. In some of these embodiments, applying the security protocol to the sidelink communication may comprise authenticating the sidelink communication using the selected first parameter and the selected second parameter or encrypting the sidelink communication using the selected first parameter and the selected second parameter.

In some embodiments, the first method, the second method, and/or the third method may comprise providing user data and forwarding the user data to a host computer via the transmission to the base station.

According to another aspect of the disclosure, there is provided a wireless device for managing sidelink communication security. The wireless device comprises processing circuitry configured to perform any of the steps of the first method, the second method, and/or the third method. In some embodiments, the wireless device may comprise power supply circuitry configured to supply power to the wireless device. In some embodiments, the wireless device (e.g. the transmitting wireless device, the receiving wireless device, and/or the first wireless device) may be a user equipment (UE). In some embodiments, the wireless device (e.g. the transmitting wireless device, the receiving wireless device, and/or the first wireless device) may be a vehicle or a wireless device configured to be attached to (or placed on/in) a vehicle.

According to another aspect of the disclosure, there is provided a fourth method performed by a base station serving a transmitting wireless device for generation of a mapping between identifiers. The fourth method comprise generating a mapping between a radio bearer identifier (Bearer ID) and a logical channel identifier (LCID). The radio bearer identifier uniquely identifies a radio bearer for a sidelink communication between the transmitting wireless device and a receiving wireless device. The LCID uniquely identifies a logical channel for the sidelink communication. The fourth method comprises transmitting the generated mapping to the transmitting wireless device.

In some embodiments, the base station may be serving the receiving wireless device and the fourth method may comprise transmitting the generated mapping to the receiving wireless device. In some embodiments, a different base station may be serving the receiving wireless device and the fourth method may comprise transmitting the generated mapping to the base station serving the receiving wireless device. In some embodiments, the fourth method may comprise obtaining user data and forwarding the user data to a host computer or a wireless device.

According to another aspect of the disclosure, there is provided a base station for generation of a mapping between identifiers. The base station comprises processing circuitry configured to perform any of the steps of the fourth method. In some embodiments, the base station may comprise power supply circuitry configured to supply power to the base station. In some embodiments, the base station may be a radio base station, such as a Node B, an evolved Node Bs (eNBs), or a new radio NodeBs (gNBs).

In some embodiments, the radio bearer identifier and the LCID referred to herein can be of the same or different formats. In some embodiments, the radio bearer identifier and the LCID referred to herein can comprise a different number of bits, e.g. the LCID may comprise a greater number of bits (e.g. one more bit) than the radio bearer identifier or vice versa. For example, in some embodiments, the LCID referred to herein may comprise 6-bits and/or the radio bearer identifier referred to herein may comprise 5-bits.

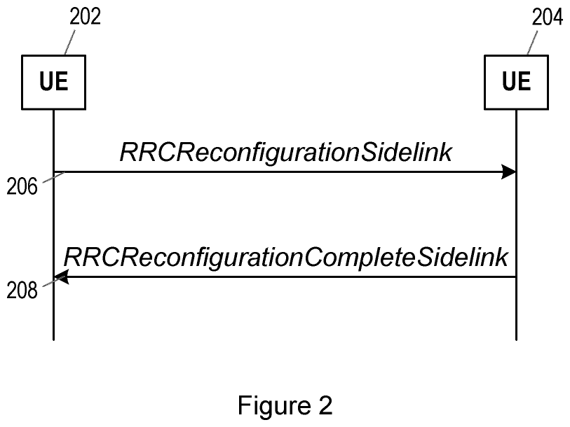

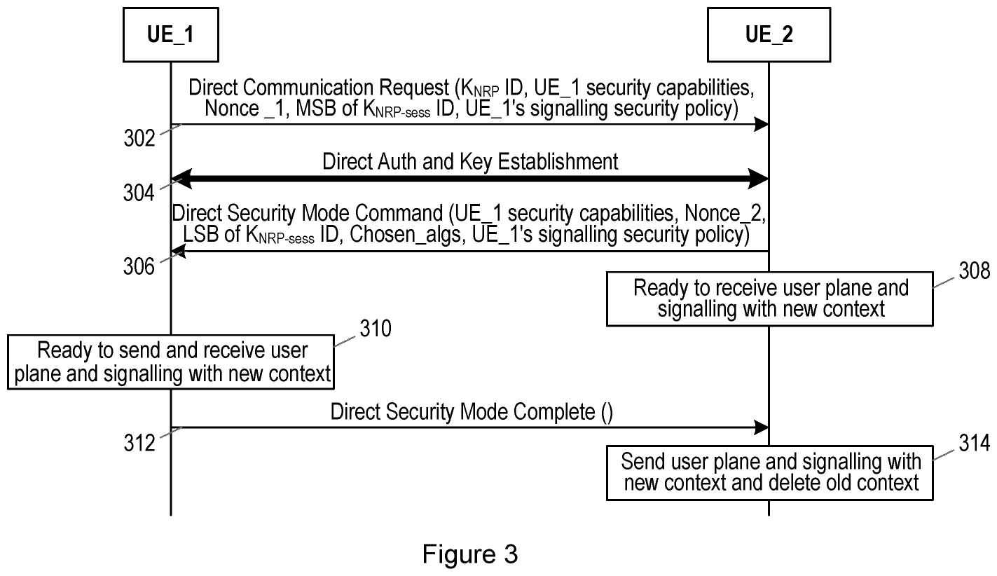

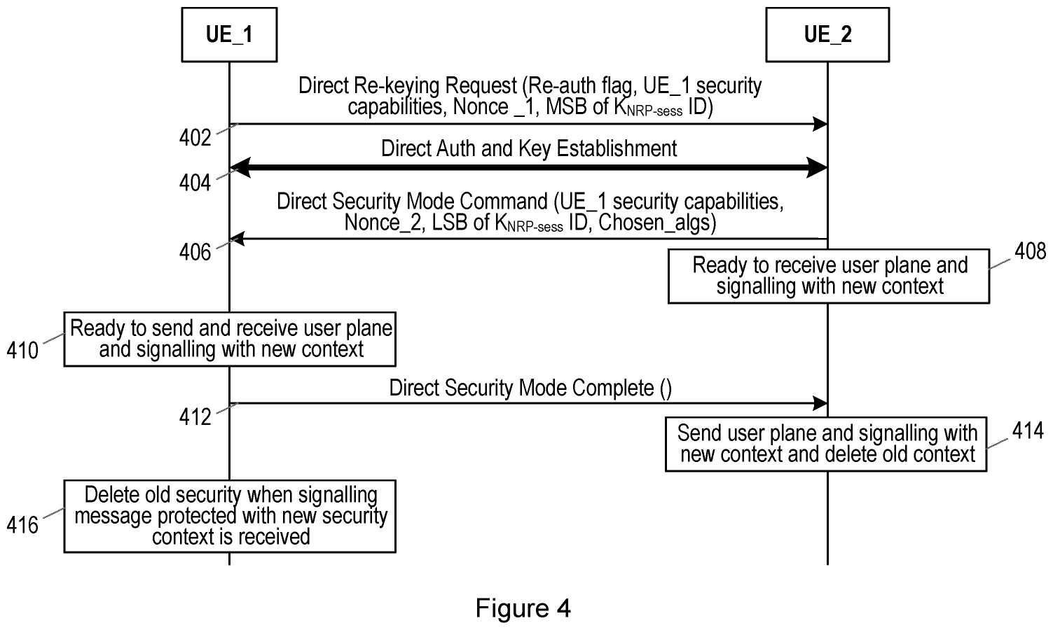

As described earlier, the transmitting wireless device generates a radio bearer identifier for use in applying a security protocol to the sidelink communication and transmits the generated radio bearer identifier to the receiving wireless device. Thus, for example, in some embodiments, when initiating a new sidelink (SL) radio bearer, the transmitting wireless device (e.g. initiating UE) may determine a value of parameter(s) (e.g. the radio bearer identifier, such as a 5-bit Bearer ID) used for security protocols (e.g. integrity/ciphering algorithms) and may indicate to the receiving wireless device (e.g. peer UE) per PC5-RRC signaling. In some embodiments, the relevant parameter(s) may be included in the RRCReconfigurationSidelink message, such as that described earlier with reference to arrow 206 of FIG. 2.

As described earlier, the base station generates a mapping between a radio bearer identifier (Bearer ID) and a logical channel identifier (LCID) and transmits the generated mapping to the transmitting wireless device. Thus, for example, in some embodiments, the mapping between the (e.g. 6-bit) logical channel identifier (LCID) and the radio bearer identifier (e.g. 5-bit bearer ID) may be decided by the base station (e.g. gNB) and forwarded to the transmitting (TX) wireless device (e.g. UE), such as upon initiating a sidelink radio bearer (SLRB). In some embodiments, the mapping between the LCID and Bearer ID may be sent to the TX wireless device (e.g. UE) via dedicated signaling in e.g., a RRCReconfiguration message. In some embodiments, the mapping between the LCID and Bearer ID may be sent to the TX wireless device (e.g. UE) via a system information block (SIB). The SIB can be a message broadcast by the base station (e.g. gNB) to the wireless devices (e.g. UEs) under its coverage (or that it is serving).

As described earlier, in some embodiments where the TX wireless device retrieves the mapping of the Bearer ID to the LCID from a memory of the TX wireless device, which comprises a plurality of mappings of Bearer IDs to respective LCIDS, the mapping of the generated Bearer ID to the LCID is selected from the plurality of mappings. As also mentioned earlier, in some embodiments, the memory can be a SIM card or any other type of memory. Thus, for example, in some embodiments, the mapping between the (e.g. 6-bit) LCID and the (e.g. 5-bit) Bearer ID may be hardcoded in the specification e.g., pre-configured in a memory (e.g. the SIM card) of the TX wireless device (e.g. UE) and/or a memory (e.g. the SIM card) of the receiving (RX) wireless devices (e.g. UEs).

In some embodiments, in order to guarantee that two peer SL wireless devices (e.g. UEs) have a different mapping for the LCID and Bearer ID (and thus decrease the re-use of the same security keys), a table with different mapping combinations may be standardized in the specification (e.g. in the memory, such as the sim card, of the TX wireless device (e.g. UE) and RX wireless device (e.g. UE)) and the TX wireless device may select one combination to be used. In some embodiments, each combination can be identified by an identifier (ID) e.g., ID 1 Mapping 1, ID 2 Mapping 2 and so on. Although this is provided as an example, it will be understood that IDs and mapping combinations may not necessarily follow the same order but can be e.g., ID 5 mapping 10.

In some embodiments, if the table with the different mapping combinations is pre-configured in the memories (e.g. SIM cards) of the TX wireless device (e.g. UE) and RX wireless devices (UEs), the TX wireless device (e.g. UE) may select a certain combination and send the corresponding ID to the RX wireless device (UE), e.g. when configuring an SLRB, such as via PC5-RRC (e.g. within the RRCReconfigurationSidelink message, such as that described earlier with reference to arrow 206 of FIG. 2).

As mentioned earlier, in some embodiments, the RX wireless device may receive a mapping of the Bearer ID to the LCID and, if the RX wireless device is already configured to use a different mapping, the RX wireless device may reconfigure itself to use the received mapping instead. Thus, for example, upon receiving the mapping between the (e.g. 6-bit) LCID and the (e.g. 5-bit) Bearer ID from the TX wireless device (UE), in some embodiments, if the RX wireless device (e.g. UE) is already configured with a mapping, it may release it and apply the new one. As also mentioned earlier, in some embodiments, the RX wireless device may receive a mapping of the Bearer ID to the LCID and, if the RX wireless device is already configured to use a different mapping, the RX wireless device may reject the received mapping and transmit the different mapping to the TX wireless device. Thus, for example, in some embodiments, upon receiving the mapping between the (e.g. 6-bit) LCID and the (e.g. 5-bit) Bearer ID from the TX wireless device (e.g. UE), if the RX wireless device (e.g. UE) is already configured with a mapping, it may reject the received configuration and send to the TX wireless device (e.g. UE) the current mapping that it is using. As also mentioned earlier, in some embodiments, the RX wireless device may receive a mapping of the Bearer ID to the LCID and, if the RX wireless device is not already configured to use a mapping, the RX wireless device may configure itself to use the received mapping. As also mentioned earlier, in some embodiments, the RX wireless device may inform its base station that it is configured to use the received mapping. Thus, for example, in some embodiments, upon receiving the mapping between the (e.g. 6-bit) LCID and the (e.g. 5-bit) bearer ID from the TX wireless device (e.g. UE), if the RX wireless device (e.g. UE) has no mapping currently configured, it may apply the received mapping and inform its base station (e.g. gNB) and a mapping can be configured. The base station of the RX wireless device (e.g. UE) may not necessarily be the same as the base station of the TX wireless device (e.g. UE).

As mentioned earlier, in some embodiments where a different base station is serving the RX wireless device, the base station serving the TX wireless device may transmit the generated mapping (between the Bearer ID and the LCID) to the base station serving the RX wireless device. Thus, for example, in case the TX wireless device (e.g. UE) and RX wireless device (e.g. UE) are served by (e.g. under the coverage of) two different base stations (e.g. gNBs), if a first base station (e.g. gNB1) decides a certain mapping for the TX wireless device (e.g. UE), in some embodiments, this mapping may be sent to a second base station (e.g. gNB2) so that this second base station can configure the same mapping for the RX wireless device (e.g. UE). In some embodiments, the first base station (e.g. gNB1) may send the mapping to the second base station (e.g. gNB2) via inter-node RRC messages. In some embodiments, the first base station (e.g. gNB1) may send the mapping to the second base station (e.g. gNB2) via Xn/X2 signaling.

As mentioned earlier, in some embodiments, a first wireless device selects a first parameter (e.g. Bearer ID) and a second parameter (e.g. a cryptographic key) for use in applying a security protocol to a sidelink communication between the first wireless device and a second wireless device and, in some embodiments, the first parameter and second parameter may be previously unused together in the application of a security protocol to a sidelink communication between the first wireless device and the second wireless device. Thus, for example, in some embodiments, the first wireless device (e.g. UE) may not indicate the first parameter but may make sure that the same first parameter is not re-used with the same second parameter. As also mentioned earlier, in some embodiments, the first wireless device may initiate a refresh procedure to refresh the second parameter such that the second parameter is previously unused in the application of a security protocol to a sidelink communication between the first wireless device and the second wireless device. Thus, for example, in some embodiments, when the first wireless device (e.g. UE) selects the same parameters again, the first wireless device (e.g. UE) may initiate the refresh procedure to generate new parameters and thus avoid using the same second parameter with the same first parameter. In a more specific example, the first wireless device (e.g. UE) may not indicate the value of the (e.g. 5-bit) Bearer ID parameters but may make sure that the same value is not re-used with the same security keys. More precisely, when the first wireless device (e.g. UE) selects the same values again, the first wireless device (e.g. UE) may initiate a key refresh procedure to generate new keys and thus avoid using the same key with the same (e.g. 5-bit) Bearer ID value.

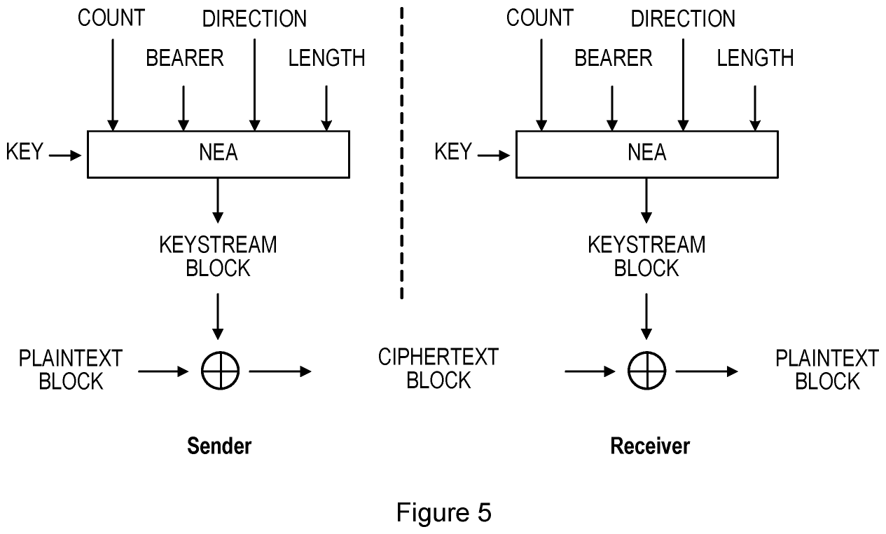

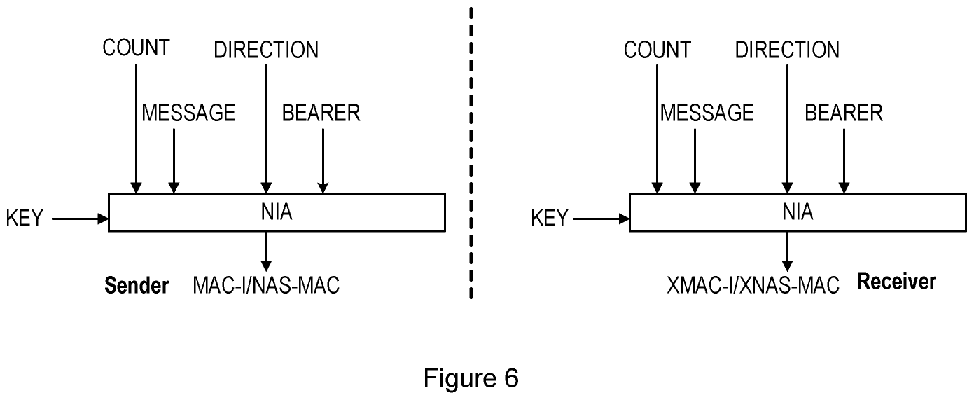

As mentioned earlier, the TX wireless device, the RX wireless device, and/or the first wireless device may apply a security protocol to a sidelink communication. In some embodiments, the respective wireless device (e.g. UE) may use (e.g. all the bits from) the LCID in the input for such a security protocol (e.g. integrity and ciphering algorithms) as described in the following. FIGS. 5 and 6 show the input for the ciphering and integrity algorithms from TS 33.501. FIG. 5 illustrates the ciphering of data, whereas FIG. 6 illustrates the derivation of an authentication code. More specifically, FIG. 6 illustrates the derivation of a Message Authentication Code for Integrity (MAC-I), or a Non Access Stratum for a Message Authentication Code (NAS-MAC), or a version (X) of either of these (XMAC-I/XNAS-MAC), i.e. MAC-I/NAS-MAC (or XMAC-I/XNAS-MAC). The LCID is the KEY in FIGS. 5 and 6. Assuming that the LCID comprises 6-bits and 5 of the LCID bits are mapped to the BEARER input, the proposal is to map the remaining 6th bit to one of the other inputs, namely one of the COUNT input, the DIRECTION input, or the LENGTH input. The most appropriate choice may be the COUNT input. In fact, using the most significant bit (MSB) of the COUNT input may be most appropriate. The end result can, for example, be that the COUNT range is reduced from 32 bits to 31 bits. However, it will be understood that this is only one of many examples and any other input may be selected in other examples.

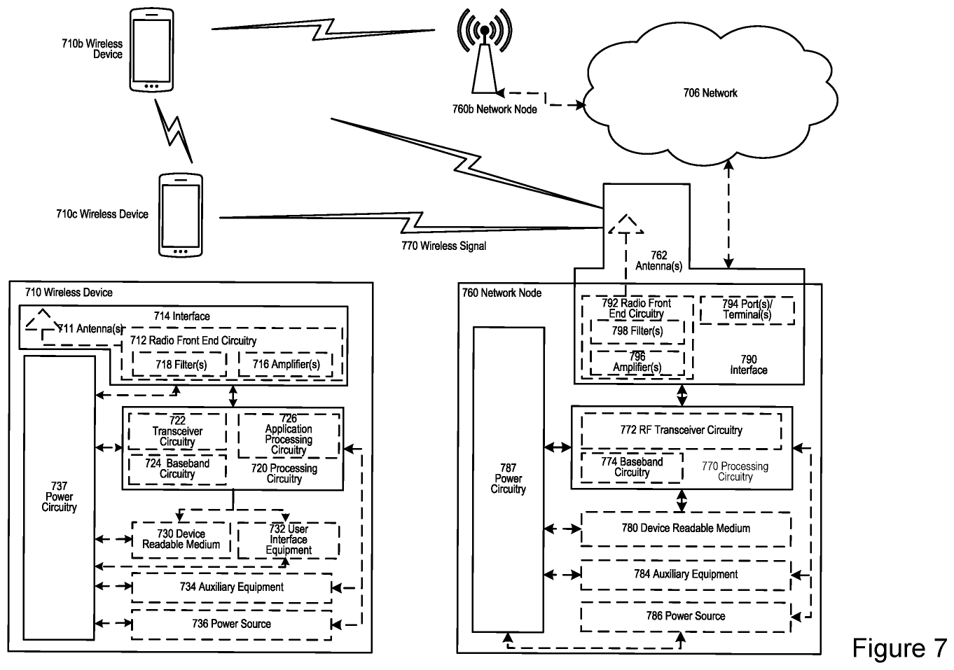

FIG. 7 illustrates a wireless network in accordance with some embodiments. Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 706, network nodes 760 and 760b, and WDs 710, 710b, and 710c. In practice, a wireless network may further include any additional elements suitable to support communication between wireless devices or between a wireless device and another communication device, such as a landline telephone, a service provider, or any other network node or end device. Of the illustrated components, network node 760 and wireless device (WD) 710 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 760 and WD 710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 7, network node 760 includes processing circuitry 770, device readable medium 780, interface 790, auxiliary equipment 784, power source 786, power circuitry 787, and antenna 762. Although network node 760 illustrated in the example wireless network of FIG. 7 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 760 are depicted as single boxes located within a larger box, or nested within multiple boxes, in practice, a network node may comprise multiple different physical components that make up a single illustrated component (e.g., device readable medium 780 may comprise multiple separate hard drives as well as multiple RAM modules).

Similarly, network node 760 may be composed of multiple physically separate components (e.g., a NodeB component and a RNC component, or a BTS component and a BSC component, etc.), which may each have their own respective components. In certain scenarios in which network node 760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 760 may be configured to support multiple radio access technologies (RATs). In such embodiments, some components may be duplicated (e.g., separate device readable medium 780 for the different RATs) and some components may be reused (e.g., the same antenna 762 may be shared by the RATs). Network node 760 may also include multiple sets of the various illustrated components for different wireless technologies integrated into network node 760, such as, for example, GSM, WCDMA, LTE, NR, WiFi, or Bluetooth wireless technologies. These wireless technologies may be integrated into the same or different chip or set of chips and other components within network node 760.

Processing circuitry 770 is configured to perform any determining, calculating, or similar operations (e.g., certain obtaining operations) described herein as being provided by a network node. These operations performed by processing circuitry 770 may include processing information obtained by processing circuitry 770 by, for example, converting the obtained information into other information, comparing the obtained information or converted information to information stored in the network node, and/or performing one or more operations based on the obtained information or converted information, and as a result of said processing making a determination.

Processing circuitry 770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 760 components, such as device readable medium 780, network node 760 functionality. For example, processing circuitry 770 may execute instructions stored in device readable medium 780 or in memory within processing circuitry 770. Such functionality may include providing any of the various wireless features, functions, or benefits discussed herein. In some embodiments, processing circuitry 770 may include a system on a chip (SOC).

In some embodiments, processing circuitry 770 may include one or more of radio frequency (RF) transceiver circuitry 772 and baseband processing circuitry 774. In some embodiments, radio frequency (RF) transceiver circuitry 772 and baseband processing circuitry 774 may be on separate chips (or sets of chips), boards, or units, such as radio units and digital units. In alternative embodiments, part or all of RF transceiver circuitry 772 and baseband processing circuitry 774 may be on the same chip or set of chips, boards, or units

In certain embodiments, some or all of the functionality described herein as being provided by a network node, base station, eNB or other such network device may be performed by processing circuitry 770 executing instructions stored on device readable medium 780 or memory within processing circuitry 770. In alternative embodiments, some or all of the functionality may be provided by processing circuitry 770 without executing instructions stored on a separate or discrete device readable medium, such as in a hard-wired manner. In any of those embodiments, whether executing instructions stored on a device readable storage medium or not, processing circuitry 770 can be configured to perform the described functionality. The benefits provided by such functionality are not limited to processing circuitry 770 alone or to other components of network node 760, but are enjoyed by network node 760 as a whole, and/or by end users and the wireless network generally.

Device readable medium 780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 770. Device readable medium 780 may store any suitable instructions, data or information, including a computer program, software, an application including one or more of logic, rules, code, tables, etc. and/or other instructions capable of being executed by processing circuitry 770 and, utilized by network node 760. Device readable medium 780 may be used to store any calculations made by processing circuitry 770 and/or any data received via interface 790. In some embodiments, processing circuitry 770 and device readable medium 780 may be considered to be integrated.

Interface 790 is used in the wired or wireless communication of signaling and/or data between network node 760, network 706, and/or WDs 710. As illustrated, interface 790 comprises port(s)/terminal(s) 794 to send and receive data, for example to and from network 706 over a wired connection. Interface 790 also includes radio front end circuitry 792 that may be coupled to, or in certain embodiments a part of, antenna 762. Radio front end circuitry 792 comprises filters 798 and amplifiers 796. Radio front end circuitry 792 may be connected to antenna 762 and processing circuitry 770. Radio front end circuitry may be configured to condition signals communicated between antenna 762 and processing circuitry 770. Radio front end circuitry 792 may receive digital data that is to be sent out to other network nodes or WDs via a wireless connection. Radio front end circuitry 792 may convert the digital data into a radio signal having the appropriate channel and bandwidth parameters using a combination of filters 798 and/or amplifiers 796. The radio signal may then be transmitted via antenna 762. Similarly, when receiving data, antenna 762 may collect radio signals which are then converted into digital data by radio front end circuitry 792. The digital data may be passed to processing circuitry 770. In other embodiments, the interface may comprise different components and/or different combinations of components.

In certain alternative embodiments, network node 760 may not include separate radio front end circuitry 792, instead, processing circuitry 770 may comprise radio front end circuitry and may be connected to antenna 762 without separate radio front end circuitry 792. Similarly, in some embodiments, all or some of RF transceiver circuitry 772 may be considered a part of interface 790. In still other embodiments, interface 790 may include one or more ports or terminals 794, radio front end circuitry 792, and RF transceiver circuitry 772, as part of a radio unit (not shown), and interface 790 may communicate with baseband processing circuitry 774, which is part of a digital unit (not shown).

Antenna 762 may include one or more antennas, or antenna arrays, configured to send and/or receive wireless signals. Antenna 762 may be coupled to radio front end circuitry 790 and may be any type of antenna capable of transmitting and receiving data and/or signals wirelessly. In some embodiments, antenna 762 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 762 may be separate from network node 760 and may be connectable to network node 760 through an interface or port.

Antenna 762, interface 790, and/or processing circuitry 770 may be configured to perform any receiving operations and/or certain obtaining operations described herein as being performed by a network node. Any information, data and/or signals may be received from a wireless device, another network node and/or any other network equipment. Similarly, antenna 762, interface 790, and/or processing circuitry 770 may be configured to perform any transmitting operations described herein as being performed by a network node. Any information, data and/or signals may be transmitted to a wireless device, another network node and/or any other network equipment.

Power circuitry 787 may comprise, or be coupled to, power management circuitry and is configured to supply the components of network node 760 with power for performing the functionality described herein. Power circuitry 787 may receive power from power source 786. Power source 786 and/or power circuitry 787 may be configured to provide power to the various components of network node 760 in a form suitable for the respective components (e.g., at a voltage and current level needed for each respective component). Power source 786 may either be included in, or external to, power circuitry 787 and/or network node 760. For example, network node 760 may be connectable to an external power source (e.g., an electricity outlet) via an input circuitry or interface such as an electrical cable, whereby the external power source supplies power to power circuitry 787. As a further example, power source 786 may comprise a source of power in the form of a battery or battery pack which is connected to, or integrated in, power circuitry 787. The battery may provide backup power should the external power source fail. Other types of power sources, such as photovoltaic devices, may also be used.

Alternative embodiments of network node 760 may include additional components beyond those shown in FIG. 7 that may be responsible for providing certain aspects of the network node's functionality, including any of the functionality described herein and/or any functionality necessary to support the subject matter described herein. For example, network node 760 may include user interface equipment to allow input of information into network node 760 and to allow output of information from network node 760. This may allow a user to perform diagnostic, maintenance, repair, and other administrative functions for network node 760.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 710 includes antenna 711, interface 714, processing circuitry 720, device readable medium 730, user interface equipment 732, auxiliary equipment 734, power source 736 and power circuitry 737. WD 710 may include multiple sets of one or more of the illustrated components for different wireless technologies supported by WD 710, such as, for example, GSM, WCDMA, LTE, NR, WiFi, WiMAX, or Bluetooth wireless technologies, just to mention a few. These wireless technologies may be integrated into the same or different chips or set of chips as other components within WD 710.

Antenna 711 may include one or more antennas or antenna arrays, configured to send and/or receive wireless signals, and is connected to interface 714. In certain alternative embodiments, antenna 711 may be separate from WD 710 and be connectable to WD 710 through an interface or port. Antenna 711, interface 714, and/or processing circuitry 720 may be configured to perform any receiving or transmitting operations described herein as being performed by a WD. Any information, data and/or signals may be received from a network node and/or another WD. In some embodiments, radio front end circuitry and/or antenna 711 may be considered an interface. As illustrated, wireless devices 710b and 710c can communicate with each other via a sidelink. A sidelink communication can be defined as a (direct) communication between wireless devices 710b and 710c without a relay through a base station.

As illustrated, interface 714 comprises radio front end circuitry 712 and antenna 711. Radio front end circuitry 712 comprise one or more filters 718 and amplifiers 716. Radio front end circuitry 714 is connected to antenna 711 and processing circuitry 720, and is configured to condition signals communicated between antenna 711 and processing circuitry 720. Radio front end circuitry 712 may be coupled to or a part of antenna 711. In some embodiments, WD 710 may not include separate radio front end circuitry 712; rather, processing circuitry 720 may comprise radio front end circuitry and may be connected to antenna 711. Similarly, in some embodiments, some or all of RF transceiver circuitry 722 may be considered a part of interface 714. Radio front end circuitry 712 may receive digital data that is to be sent out to other network nodes or WDs via a wireless connection. Radio front end circuitry 712 may convert the digital data into a radio signal having the appropriate channel and bandwidth parameters using a combination of filters 718 and/or amplifiers 716. The radio signal may then be transmitted via antenna 711. Similarly, when receiving data, antenna 711 may collect radio signals which are then converted into digital data by radio front end circuitry 712. The digital data may be passed to processing circuitry 720. In other embodiments, the interface may comprise different components and/or different combinations of components.

Processing circuitry 720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 710 components, such as device readable medium 730, WD 710 functionality. Such functionality may include providing any of the various wireless features or benefits discussed herein. For example, processing circuitry 720 may execute instructions stored in device readable medium 730 or in memory within processing circuitry 720 to provide the functionality disclosed herein.

As illustrated, processing circuitry 720 includes one or more of RF transceiver circuitry 722, baseband processing circuitry 724, and application processing circuitry 726. In other embodiments, the processing circuitry may comprise different components and/or different combinations of components. In certain embodiments processing circuitry 720 of WD 710 may comprise a SOC. In some embodiments, RF transceiver circuitry 722, baseband processing circuitry 724, and application processing circuitry 726 may be on separate chips or sets of chips. In alternative embodiments, part or all of baseband processing circuitry 724 and application processing circuitry 726 may be combined into one chip or set of chips, and RF transceiver circuitry 722 may be on a separate chip or set of chips. In still alternative embodiments, part or all of RF transceiver circuitry 722 and baseband processing circuitry 724 may be on the same chip or set of chips, and application processing circuitry 726 may be on a separate chip or set of chips. In yet other alternative embodiments, part or all of RF transceiver circuitry 722, baseband processing circuitry 724, and application processing circuitry 726 may be combined in the same chip or set of chips. In some embodiments, RF transceiver circuitry 722 may be a part of interface 714. RF transceiver circuitry 722 may condition RF signals for processing circuitry 720.

In certain embodiments, some or all of the functionality described herein as being performed by a WD may be provided by processing circuitry 720 executing instructions stored on device readable medium 730, which in certain embodiments may be a computer-readable storage medium. In alternative embodiments, some or all of the functionality may be provided by processing circuitry 720 without executing instructions stored on a separate or discrete device readable storage medium, such as in a hard-wired manner. In any of those particular embodiments, whether executing instructions stored on a device readable storage medium or not, processing circuitry 720 can be configured to perform the described functionality. The benefits provided by such functionality are not limited to processing circuitry 720 alone or to other components of WD 710, but are enjoyed by WD 710 as a whole, and/or by end users and the wireless network generally.

Processing circuitry 720 may be configured to perform any determining, calculating, or similar operations (e.g., certain obtaining operations) described herein as being performed by a WD. These operations, as performed by processing circuitry 720, may include processing information obtained by processing circuitry 720 by, for example, converting the obtained information into other information, comparing the obtained information or converted information to information stored by WD 710, and/or performing one or more operations based on the obtained information or converted information, and as a result of said processing making a determination.

Device readable medium 730 may be operable to store a computer program, software, an application including one or more of logic, rules, code, tables, etc. and/or other instructions capable of being executed by processing circuitry 720. Device readable medium 730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 720. In some embodiments, processing circuitry 720 and device readable medium 730 may be considered to be integrated.

User interface equipment 732 may provide components that allow for a human user to interact with WD 710. Such interaction may be of many forms, such as visual, audial, tactile, etc. User interface equipment 732 may be operable to produce output to the user and to allow the user to provide input to WD 710. The type of interaction may vary depending on the type of user interface equipment 732 installed in WD 710. For example, if WD 710 is a smart phone, the interaction may be via a touch screen; if WD 710 is a smart meter, the interaction may be through a screen that provides usage (e.g., the number of gallons used) or a speaker that provides an audible alert (e.g., if smoke is detected). User interface equipment 732 may include input interfaces, devices and circuits, and output interfaces, devices and circuits. User interface equipment 732 is configured to allow input of information into WD 710, and is connected to processing circuitry 720 to allow processing circuitry 720 to process the input information. User interface equipment 732 may include, for example, a microphone, a proximity or other sensor, keys/buttons, a touch display, one or more cameras, a USB port, or other input circuitry. User interface equipment 732 is also configured to allow output of information from WD 710, and to allow processing circuitry 720 to output information from WD 710. User interface equipment 732 may include, for example, a speaker, a display, vibrating circuitry, a USB port, a headphone interface, or other output circuitry. Using one or more input and output interfaces, devices, and circuits, of user interface equipment 732, WD 710 may communicate with end users and/or the wireless network, and allow them to benefit from the functionality described herein.

Auxiliary equipment 734 is operable to provide more specific functionality which may not be generally performed by WDs. This may comprise specialized sensors for doing measurements for various purposes, interfaces for additional types of communication such as wired communications etc. The inclusion and type of components of auxiliary equipment 734 may vary depending on the embodiment and/or scenario.

Power source 736 may, in some embodiments, be in the form of a battery or battery pack. Other types of power sources, such as an external power source (e.g., an electricity outlet), photovoltaic devices or power cells, may also be used. WD 710 may further comprise power circuitry 737 for delivering power from power source 736 to the various parts of WD 710 which need power from power source 736 to carry out any functionality described or indicated herein. Power circuitry 737 may in certain embodiments comprise power management circuitry. Power circuitry 737 may additionally or alternatively be operable to receive power from an external power source; in which case WD 710 may be connectable to the external power source (such as an electricity outlet) via input circuitry or an interface such as an electrical power cable. Power circuitry 737 may also in certain embodiments be operable to deliver power from an external power source to power source 736. This may be, for example, for the charging of power source 736. Power circuitry 737 may perform any formatting, converting, or other modification to the power from power source 736 to make the power suitable for the respective components of WD 710 to which power is supplied.

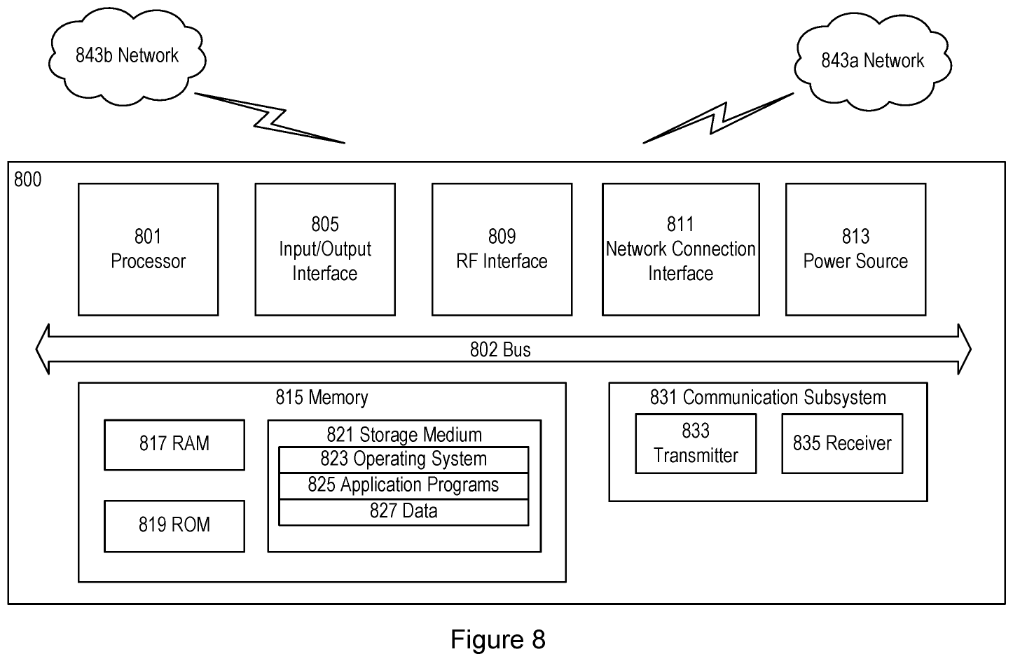

FIG. 8 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 800 may be any UE identified by the 3^{rd} Generation Partnership Project (3GPP), including a NB-IoT UE, a machine type communication (MTC) UE, and/or an enhanced MTC (eMTC) UE. UE 800, as illustrated in FIG. 8, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 8 is a UE, the components discussed herein are equally applicable to a WD, and vice-versa.

In FIG. 8, UE 800 includes processing circuitry 801 that is operatively coupled to input/output interface 805, radio frequency (RF) interface 809, network connection interface 811, memory 815 including random access memory (RAM) 817, read-only memory (ROM) 819, and storage medium 821 or the like, communication subsystem 831, power source 813, and/or any other component, or any combination thereof. Storage medium 821 includes operating system 823, application program 825, and data 827. In other embodiments, storage medium 821 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 801 may be configured to process computer instructions and data. Processing circuitry 801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 801 may include two central processing units (CPUs). Data may be information in a form suitable for use by a computer.

In the depicted embodiment, input/output interface 805 may be configured to provide a communication interface to an input device, output device, or input and output device. UE 800 may be configured to use an output device via input/output interface 805. An output device may use the same type of interface port as an input device. For example, a USB port may be used to provide input to and output from UE 800. The output device may be a speaker, a sound card, a video card, a display, a monitor, a printer, an actuator, an emitter, a smartcard, another output device, or any combination thereof. UE 800 may be configured to use an input device via input/output interface 805 to allow a user to capture information into UE 800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 809 may be configured to provide a communication interface to RF components such as a transmitter, a receiver, and an antenna. Network connection interface 811 may be configured to provide a communication interface to network 843a. Network 843a may encompass wired and/or wireless networks such as a local-area network (LAN), a wide-area network (WAN), a computer network, a wireless network, a telecommunications network, another like network or any combination thereof. For example, network 843a may comprise a Wi-Fi network. Network connection interface 811 may be configured to include a receiver and a transmitter interface used to communicate with one or more other devices over a communication network according to one or more communication protocols, such as Ethernet, TCP/IP, SONET, ATM, or the like. Network connection interface 811 may implement receiver and transmitter functionality appropriate to the communication network links (e.g., optical, electrical, and the like). The transmitter and receiver functions may share circuit components, software or firmware, or alternatively may be implemented separately.

RAM 817 may be configured to interface via bus 802 to processing circuitry 801 to provide storage or caching of data or computer instructions during the execution of software programs such as the operating system, application programs, and device drivers. ROM 819 may be configured to provide computer instructions or data to processing circuitry 801. For example, ROM 819 may be configured to store invariant low-level system code or data for basic system functions such as basic input and output (I/O), startup, or reception of keystrokes from a keyboard that are stored in a non-volatile memory. Storage medium 821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 821 may be configured to include operating system 823, application program 825 such as a web browser application, a widget or gadget engine or another application, and data file 827. Storage medium 821 may store, for use by UE 800, any of a variety of various operating systems or combinations of operating systems.

Storage medium 821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 821 may allow UE 800 to access computer-executable instructions, application programs or the like, stored on transitory or non-transitory memory media, to off-load data, or to upload data. An article of manufacture, such as one utilizing a communication system may be tangibly embodied in storage medium 821, which may comprise a device readable medium.

In FIG. 8, processing circuitry 801 may be configured to communicate with network 843b using communication subsystem 831. Network 843a and network 843b may be the same network or networks or different network or networks. Communication subsystem 831 may be configured to include one or more transceivers used to communicate with network 843b. For example, communication subsystem 831 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 833 and/or receiver 835 to implement transmitter or receiver functionality, respectively, appropriate to the RAN links (e.g., frequency allocations and the like). Further, transmitter 833 and receiver 835 of each transceiver may share circuit components, software or firmware, or alternatively may be implemented separately.

In the illustrated embodiment, the communication functions of communication subsystem 831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 831 may include cellular communication, Wi-Fi communication, Bluetooth communication, and GPS communication. Network 843b may encompass wired and/or wireless networks such as a local-area network (LAN), a wide-area network (WAN), a computer network, a wireless network, a telecommunications network, another like network or any combination thereof. For example, network 843b may be a cellular network, a Wi-Fi network, and/or a near-field network. Power source 813 may be configured to provide alternating current (AC) or direct current (DC) power to components of UE 800.

The features, benefits and/or functions described herein may be implemented in one of the components of UE 800 or partitioned across multiple components of UE 800. Further, the features, benefits, and/or functions described herein may be implemented in any combination of hardware, software or firmware. In one example, communication subsystem 831 may be configured to include any of the components described herein. Further, processing circuitry 801 may be configured to communicate with any of such components over bus 802. In another example, any of such components may be represented by program instructions stored in memory that when executed by processing circuitry 801 perform the corresponding functions described herein. In another example, the functionality of any of such components may be partitioned between processing circuitry 801 and communication subsystem 831. In another example, the non-computationally intensive functions of any of such components may be implemented in software or firmware and the computationally intensive functions may be implemented in hardware.

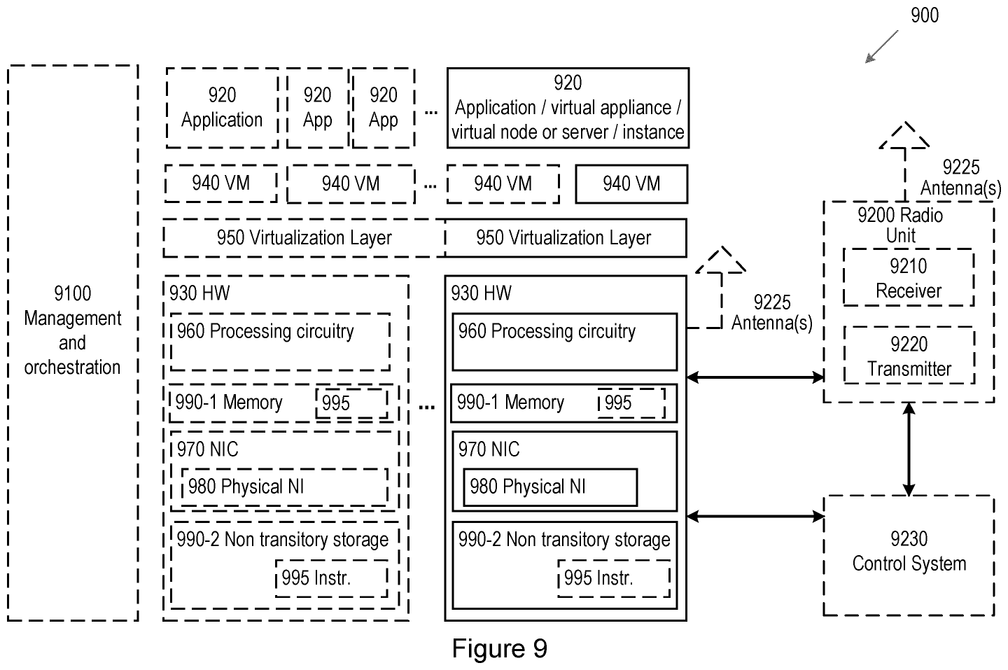

FIG. 9 is a schematic illustrating a virtualization environment in accordance with some embodiments. More specifically, FIG. 9 is a schematic block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 900 hosted by one or more of hardware nodes 930. Further, in embodiments in which the virtual node is not a radio access node or does not require radio connectivity (e.g., a core network node), then the network node may be entirely virtualized.

The functions may be implemented by one or more applications 920 (which may alternatively be called software instances, virtual appliances, network functions, virtual nodes, virtual network functions, etc.) operative to implement some of the features, functions, and/or benefits of some of the embodiments disclosed herein. Applications 920 are run in virtualization environment 900 which provides hardware 930 comprising processing circuitry 960 and memory 990. Memory 990 contains instructions 995 executable by processing circuitry 960 whereby application 920 is operative to provide one or more of the features, benefits, and/or functions disclosed herein.

Virtualization environment 900, comprises general-purpose or special-purpose network hardware devices 930 comprising a set of one or more processors or processing circuitry 960, which may be commercial off-the-shelf (COTS) processors, dedicated Application Specific Integrated Circuits (ASICs), or any other type of processing circuitry including digital or analog hardware components or special purpose processors. Each hardware device may comprise memory 990-1 which may be non-persistent memory for temporarily storing instructions 995 or software executed by processing circuitry 960. Each hardware device may comprise one or more network interface controllers (NICs) 970, also known as network interface cards, which include physical network interface 980. Each hardware device may also include non-transitory, persistent, machine-readable storage media 990-2 having stored therein software 995 and/or instructions executable by processing circuitry 960. Software 995 may include any type of software including software for instantiating one or more virtualization layers 950 (also referred to as hypervisors), software to execute virtual machines 940 as well as software allowing it to execute functions, features and/or benefits described in relation with some embodiments described herein.

Virtual machines 940, comprise virtual processing, virtual memory, virtual networking or interface and virtual storage, and may be run by a corresponding virtualization layer 950 or hypervisor. Different embodiments of the instance of virtual application 920 may be implemented on one or more of virtual machines 940, and the implementations may be made in different ways.

During operation, processing circuitry 960 executes software 995 to instantiate the hypervisor or virtualization layer 950, which may sometimes be referred to as a virtual machine monitor (VMM). Virtualization layer 950 may present a virtual operating platform that appears like networking hardware to virtual machine 940.

As shown in FIG. 9, hardware 930 may be a standalone network node with generic or specific components. Hardware 930 may comprise antenna 9225 and may implement some functions via virtualization. Alternatively, hardware 930 may be part of a larger cluster of hardware (e.g. such as in a data center or customer premise equipment (CPE)) where many hardware nodes work together and are managed via management and orchestration (MANO) 9100, which, among others, oversees lifecycle management of applications 920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 940 may be a software implementation of a physical machine that runs programs as if they were executing on a physical, non-virtualized machine. Each of virtual machines 940, and that part of hardware 930 that executes that virtual machine, be it hardware dedicated to that virtual machine and/or hardware shared by that virtual machine with others of the virtual machines 940, forms a separate virtual network elements (VNE).

Still in the context of NFV, Virtual Network Function (VNF) is responsible for handling specific network functions that run in one or more virtual machines 940 on top of hardware networking infrastructure 930 and corresponds to application 920 in FIG. 9.

In some embodiments, one or more radio units 9200 that each include one or more transmitters 9220 and one or more receivers 9210 may be coupled to one or more antennas 9225. Radio units 9200 may communicate directly with hardware nodes 930 via one or more appropriate network interfaces and may be used in combination with the virtual components to provide a virtual node with radio capabilities, such as a radio access node or a base station.

In some embodiments, some signaling can be effected with the use of control system 9230 which may alternatively be used for communication between the hardware nodes 930 and radio units 9200.

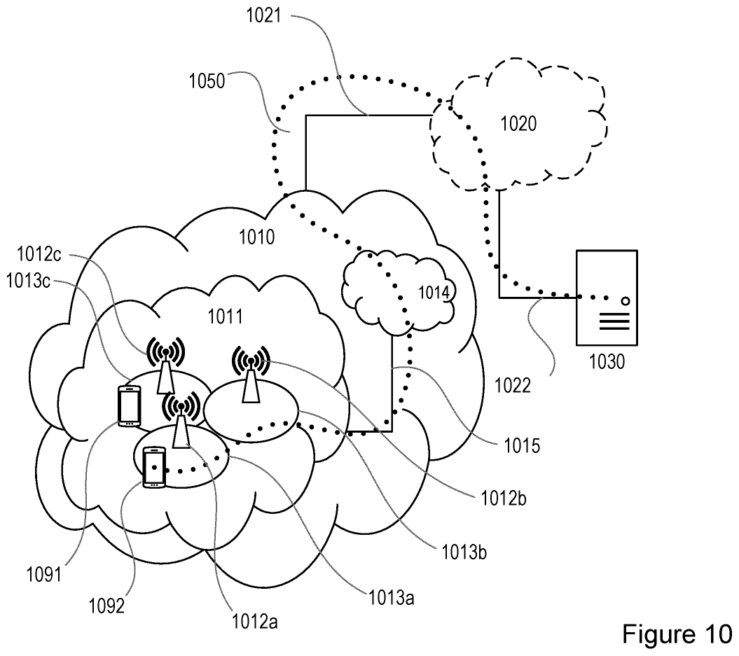

FIG. 10 is a schematic illustrating a telecommunication network connected via an intermediate network to a host computer in accordance with some embodiments. With reference to FIG. 10, in accordance with an embodiment, a communication system includes telecommunication network 1010, such as a 3GPP-type cellular network, which comprises access network 1011, such as a radio access network, and core network 1014. Access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to core network 1014 over a wired or wireless connection 1015. A first UE 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

Telecommunication network 1010 is itself connected to host computer 1030, which may be embodied in the hardware and/or software of a standalone server, a cloud-implemented server, a distributed server or as processing resources in a server farm. Host computer 1030 may be under the ownership or control of a service provider, or may be operated by the service provider or on behalf of the service provider. Connections 1021 and 1022 between telecommunication network 1010 and host computer 1030 may extend directly from core network 1014 to host computer 1030 or may go via an optional intermediate network 1020. Intermediate network 1020 may be one of, or a combination of more than one of, a public, private or hosted network; intermediate network 1020, if any, may be a backbone network or the Internet; in particular, intermediate network 1020 may comprise two or more sub-networks (not shown).

The communication system of FIG. 10 as a whole enables connectivity between the connected UEs 1091, 1092 and host computer 1030. The connectivity may be described as an over-the-top (OTT) connection 1050. Host computer 1030 and the connected UEs 1091, 1092 are configured to communicate data and/or signaling via OTT connection 1050, using access network 1011, core network 1014, any intermediate network 1020 and possible further infrastructure (not shown) as intermediaries. OTT connection 1050 may be transparent in the sense that the participating communication devices through which OTT connection 1050 passes are unaware of routing of uplink and downlink communications. For example, base station 1012 may not or need not be informed about the past routing of an incoming downlink communication with data originating from host computer 1030 to be forwarded (e.g., handed over) to a connected UE 1091. Similarly, base station 1012 need not be aware of the future routing of an outgoing uplink communication originating from the UE 1091 towards the host computer 1030.

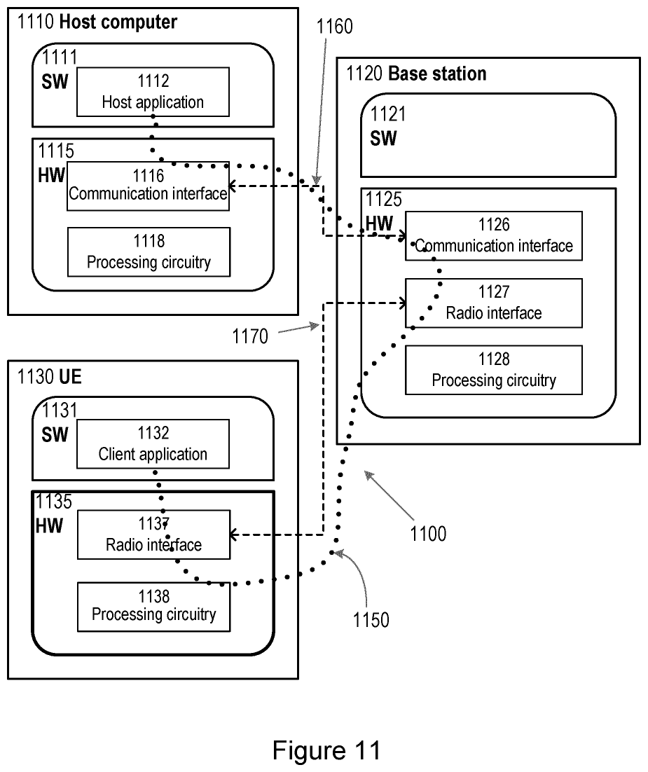

FIG. 11 is a schematic illustrating a host computer communicating via a base station with a user equipment over a partially wireless connection in accordance with some embodiments. Example implementations, in accordance with an embodiment, of the UE, base station and host computer discussed in the preceding paragraphs will now be described with reference to FIG. 11. In communication system 1100, host computer 1110 comprises hardware 1115 including communication interface 1116 configured to set up and maintain a wired or wireless connection with an interface of a different communication device of communication system 1100. Host computer 1110 further comprises processing circuitry 1118, which may have storage and/or processing capabilities. In particular, processing circuitry 1118 may comprise one or more programmable processors, application-specific integrated circuits, field programmable gate arrays or combinations of these (not shown) adapted to execute instructions. Host computer 1110 further comprises software 1111, which is stored in or accessible by host computer 1110 and executable by processing circuitry 1118. Software 1111 includes host application 1112. Host application 1112 may be operable to provide a service to a remote user, such as UE 1130 connecting via OTT connection 1150 terminating at UE 1130 and host computer 1110. In providing the service to the remote user, host application 1112 may provide user data which is transmitted using OTT connection 1150.

Communication system 1100 further includes base station 1120 provided in a telecommunication system and comprising hardware 1125 enabling it to communicate with host computer 1110 and with UE 1130. Hardware 1125 may include communication interface 1126 for setting up and maintaining a wired or wireless connection with an interface of a different communication device of communication system 1100, as well as radio interface 1127 for setting up and maintaining at least wireless connection 1170 with UE 1130 located in a coverage area (not shown in FIG. 11) served by base station 1120. Communication interface 1126 may be configured to facilitate connection 1160 to host computer 1110. Connection 1160 may be direct or it may pass through a core network (not shown in FIG. 11) of the telecommunication system and/or through one or more intermediate networks outside the telecommunication system. In the embodiment shown, hardware 1125 of base station 1120 further includes processing circuitry 1128, which may comprise one or more programmable processors, application-specific integrated circuits, field programmable gate arrays or combinations of these (not shown) adapted to execute instructions. Base station 1120 further has software 1121 stored internally or accessible via an external connection.

Communication system 1100 further includes UE 1130 already referred to. Its hardware 1135 may include radio interface 1137 configured to set up and maintain wireless connection 1170 with a base station serving a coverage area in which UE 1130 is currently located. Hardware 1135 of UE 1130 further includes processing circuitry 1138, which may comprise one or more programmable processors, application-specific integrated circuits, field programmable gate arrays or combinations of these (not shown) adapted to execute instructions. UE 1130 further comprises software 1131, which is stored in or accessible by UE 1130 and executable by processing circuitry 1138. Software 1131 includes client application 1132. Client application 1132 may be operable to provide a service to a human or non-human user via UE 1130, with the support of host computer 1110. In host computer 1110, an executing host application 1112 may communicate with the executing client application 1132 via OTT connection 1150 terminating at UE 1130 and host computer 1110. In providing the service to the user, client application 1132 may receive request data from host application 1112 and provide user data in response to the request data. OTT connection 1150 may transfer both the request data and the user data. Client application 1132 may interact with the user to generate the user data that it provides.

It is noted that host computer 1110, base station 1120 and UE 1130 illustrated in FIG. 11 may be similar or identical to host computer 1030, one of base stations 1012a, 1012b, 1012c and one of UEs 1091, 1092 of FIG. 10, respectively. This is to say, the inner workings of these entities may be as shown in FIG. 11 and independently, the surrounding network topology may be that of FIG. 10.

In FIG. 11, OTT connection 1150 has been drawn abstractly to illustrate the communication between host computer 1110 and UE 1130 via base station 1120, without explicit reference to any intermediary devices and the precise routing of messages via these devices. Network infrastructure may determine the routing, which it may be configured to hide from UE 1130 or from the service provider operating host computer 1110, or both. While OTT connection 1150 is active, the network infrastructure may further take decisions by which it dynamically changes the routing (e.g., on the basis of load balancing consideration or reconfiguration of the network).

Wireless connection 1170 between UE 1130 and base station 1120 is in accordance with the teachings of the embodiments described throughout this disclosure. One or more of the various embodiments improve the performance of OTT services provided to UE 1130 using OTT connection 1150, in which wireless connection 1170 forms the last segment. More precisely, the teachings of these embodiments may provide benefits such as enabling security for sidelink communication and/or reducing (or eliminating) the risk of key reuse.

A measurement procedure may be provided for the purpose of monitoring data rate, latency and other factors on which the one or more embodiments improve. There may further be an optional network functionality for reconfiguring OTT connection 1150 between host computer 1110 and UE 1130, in response to variations in the measurement results. The measurement procedure and/or the network functionality for reconfiguring OTT connection 1150 may be implemented in software 1111 and hardware 1115 of host computer 1110 or in software 1131 and hardware 1135 of UE 1130, or both. In embodiments, sensors (not shown) may be deployed in or in association with communication devices through which OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of OTT connection 1150 may include message format, retransmission settings, preferred routing etc.; the reconfiguring need not affect base station 1120, and it may be unknown or imperceptible to base station 1120. Such procedures and functionalities may be known and practiced in the art. In certain embodiments, measurements may involve proprietary UE signaling facilitating host computer 1110's measurements of throughput, propagation times, latency and the like. The measurements may be implemented in that software 1111 and 1131 causes messages to be transmitted, in particular empty or ‘dummy’ messages, using OTT connection 1150 while it monitors propagation times, errors etc.

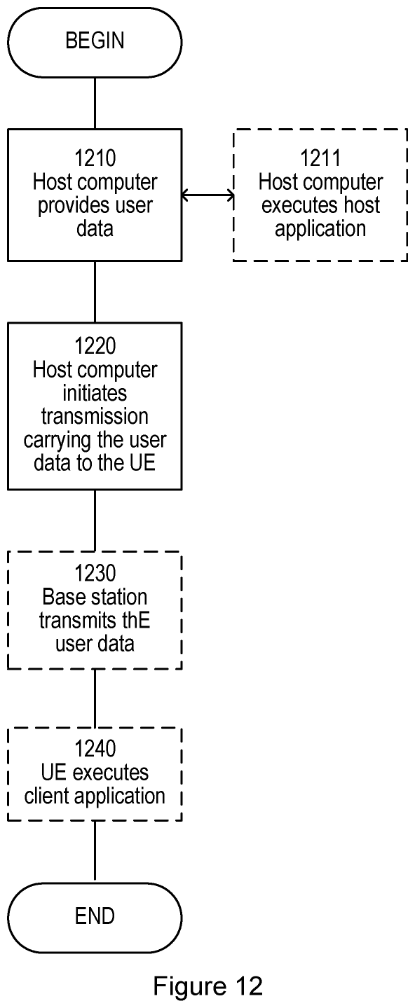

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step 1210, the host computer provides user data. In substep 1211 (which may be optional) of step 1210, the host computer provides the user data by executing a host application. In step 1220, the host computer initiates a transmission carrying the user data to the UE. In step 1230 (which may be optional), the base station transmits to the UE the user data which was carried in the transmission that the host computer initiated, in accordance with the teachings of the embodiments described throughout this disclosure. In step 1240 (which may also be optional), the UE executes a client application associated with the host application executed by the host computer.

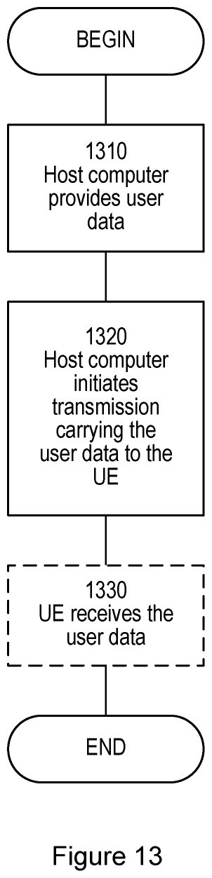

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step 1310 of the method, the host computer provides user data. In an optional substep (not shown) the host computer provides the user data by executing a host application. In step 1320, the host computer initiates a transmission carrying the user data to the UE. The transmission may pass via the base station, in accordance with the teachings of the embodiments described throughout this disclosure. In step 1330 (which may be optional), the UE receives the user data carried in the transmission.

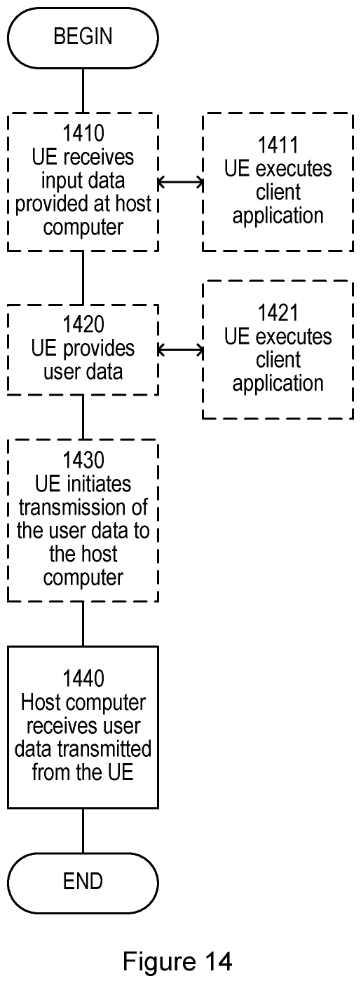

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step 1410 (which may be optional), the UE receives input data provided by the host computer. Additionally or alternatively, in step 1420, the UE provides user data. In substep 1421 (which may be optional) of step 1420, the UE provides the user data by executing a client application. In substep 1411 (which may be optional) of step 1410, the UE executes a client application which provides the user data in reaction to the received input data provided by the host computer. In providing the user data, the executed client application may further consider user input received from the user. Regardless of the specific manner in which the user data was provided, the UE initiates, in substep 1430 (which may be optional), transmission of the user data to the host computer. In step 1440 of the method, the host computer receives the user data transmitted from the UE, in accordance with the teachings of the embodiments described throughout this disclosure.

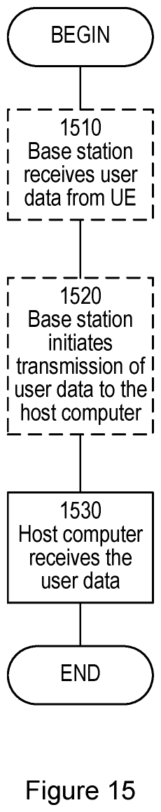

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step 1510 (which may be optional), in accordance with the teachings of the embodiments described throughout this disclosure, the base station receives user data from the UE. In step 1520 (which may be optional), the base station initiates transmission of the received user data to the host computer. In step 1530 (which may be optional), the host computer receives the user data carried in the transmission initiated by the base station.

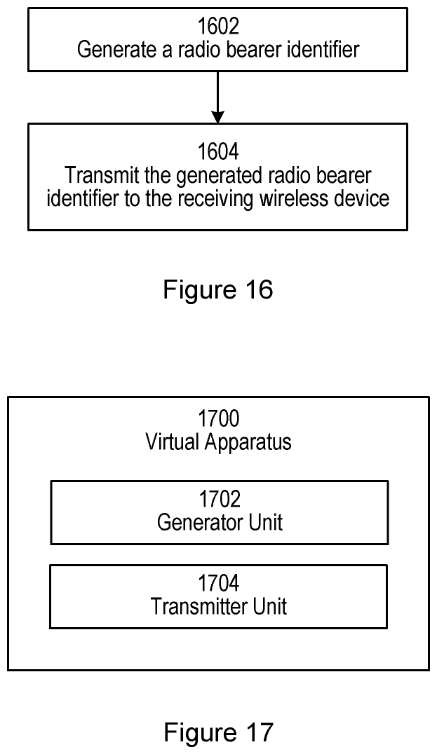

FIG. 16 illustrates a method performed by a transmitting wireless device in accordance with some embodiments. The method is for managing sidelink communication security. As illustrated in FIG. 16, at block 1602, a radio bearer identifier is generated. The generated radio bearer identifier uniquely identifies a radio bearer for a sidelink communication between the transmitting wireless device and a receiving wireless device. At block 1604 of FIG. 16, the generated radio bearer identifier is transmitted to the receiving wireless device. The generated radio bearer identifier is for use in applying a security protocol to the sidelink communication.

FIG. 17 is a block diagram of an (e.g. virtual) apparatus 1700 in a wireless network (for example, the wireless network shown in FIG. 7). The apparatus may be implemented in a wireless device (e.g., wireless device 710 shown in FIG. 7). Apparatus 1700 is operable to carry out the example method described with reference to FIG. 16 and possibly any other processes or methods disclosed herein. It is also to be understood that the method of FIG. 16 is not necessarily carried out solely by apparatus 1700. At least some operations of the method can be performed by one or more other entities.

Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

As illustrated in FIG. 17, apparatus 1700 comprises generator unit 1702 and transmitter unit 1704. The generator unit 1702 is configured to generate the radio bearer identifier. The generated radio bearer identifier uniquely identifies a radio bearer for a sidelink communication between the transmitting wireless device and a receiving wireless device. The transmitter unit 1704 is configured to transmit the generated radio bearer identifier to the receiving wireless device. The generated radio bearer identifier is for use in applying a security protocol to the sidelink communication. In some implementations, the processing circuitry may be used to cause generator unit 1702, transmitter unit 1704, and any other suitable units of apparatus 1700 to perform corresponding functions according one or more embodiments of the present disclosure.

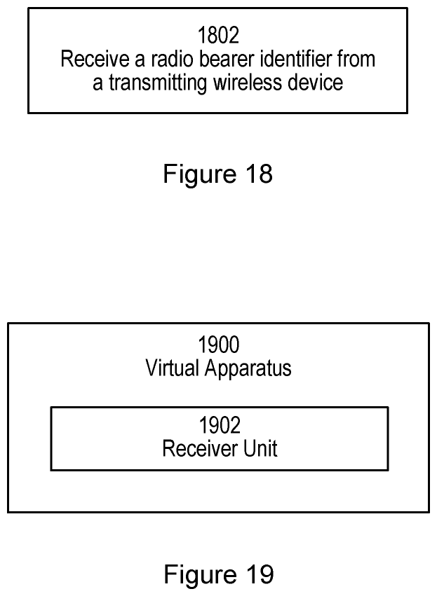

FIG. 18 illustrates a method performed by a receiving wireless device in accordance with some embodiments. The method is for managing sidelink communication security. As illustrated in FIG. 18, at block 1802, the radio bearer identifier is received from the transmitting wireless device. The radio bearer identifier uniquely identifies a radio bearer for a sidelink communication between the transmitting wireless device and the receiving wireless device. The radio bearer identifier is for use in applying a security protocol to the sidelink communication.

FIG. 19 is a schematic block diagram of an (e.g. virtual) apparatus 1900 in a wireless network (for example, the wireless network shown in FIG. 7). The apparatus may be implemented in a wireless device (e.g., wireless device 710 shown in FIG. 7). Apparatus 1900 is operable to carry out the example method described with reference to FIG. 18 and possibly any other processes or methods disclosed herein. It is also to be understood that the method of FIG. 19 is not necessarily carried out solely by apparatus 1900. At least some operations of the method can be performed by one or more other entities.

Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

As illustrated in FIG. 19, apparatus 1900 comprises receiver unit 1902. The receiver unit 1902 is configured to receive the radio bearer identifier from the transmitting wireless device. The radio bearer identifier uniquely identifies a radio bearer for a sidelink communication between the transmitting wireless device and the receiving wireless device. The radio bearer identifier is for use in applying a security protocol to the sidelink communication. In some implementations, the processing circuitry may be used to cause receiver unit 1902, and any other suitable units of apparatus 1900 to perform corresponding functions according one or more embodiments of the present disclosure.

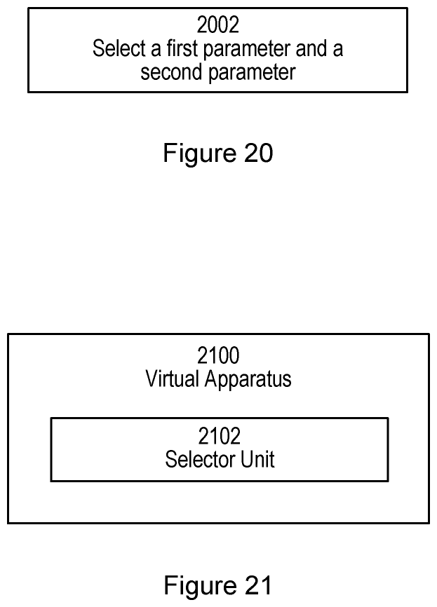

FIG. 20 illustrates a method performed by a first wireless device in accordance with some embodiments. The method is for managing sidelink communication security. As illustrated in FIG. 20, at block 2002, a first parameter and a second parameter are selected for use in applying a security protocol to a sidelink communication between the first wireless device and a second wireless device.

FIG. 21 is a schematic block diagram of an (e.g. virtual) apparatus 2100 in a wireless network (for example, the wireless network shown in FIG. 7). The apparatus may be implemented in a wireless device (e.g., wireless device 710 shown in FIG. 7). Apparatus 2100 is operable to carry out the example method described with reference to FIG. 20 and possibly any other processes or methods disclosed herein. It is also to be understood that the method of FIG. 21 is not necessarily carried out solely by apparatus 2100. At least some operations of the method can be performed by one or more other entities.

Apparatus 2100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

As illustrated in FIG. 21, apparatus 2100 comprises selector unit 2102. The selector unit 2102 is configured to select the first parameter and the second parameter for use in applying the security protocol to the sidelink communication between the first wireless device and the second wireless device. In some implementations, the processing circuitry may be used to cause receiver unit 2102, and any other suitable units of apparatus 2100 to perform corresponding functions according one or more embodiments of the present disclosure.

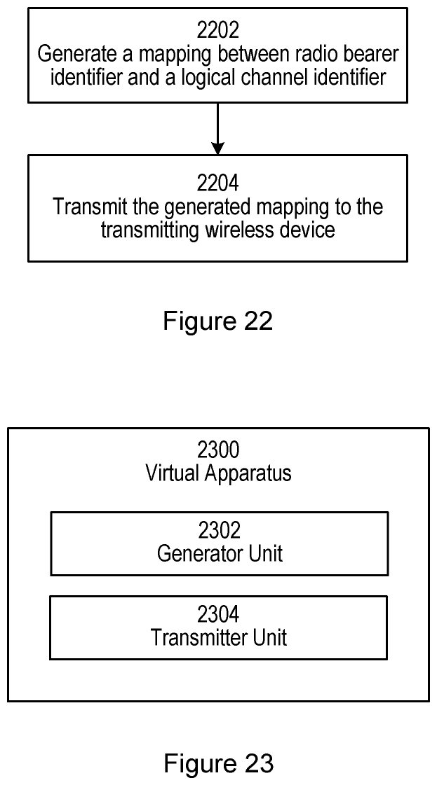

FIG. 22 illustrates a method performed by a base station serving the transmitting wireless device in accordance with some embodiments. The method is for generation of a mapping between identifiers. As illustrated in FIG. 22, at block 2202, a mapping between a radio bearer identifier and a logical channel identifier is generated. The radio bearer identifier uniquely identifies a radio bearer for a sidelink communication between the transmitting wireless device and a receiving wireless device. The logical channel identifier uniquely identifies a logical channel for the sidelink communication. At block 2204 of FIG. 22, the generated mapping is transmitted to the transmitting wireless device.

FIG. 23 is a schematic block diagram of an (e.g. virtual) apparatus 2300 in a wireless network (for example, the wireless network shown in FIG. 7). The apparatus may be implemented in a network node (e.g., network node 760 shown in FIG. 7). Apparatus 2300 is operable to carry out the example method described with reference to FIG. 22 and possibly any other processes or methods disclosed herein. It is also to be understood that the method of FIG. 23 is not necessarily carried out solely by apparatus 2300. At least some operations of the method can be performed by one or more other entities.

Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

As illustrated in FIG. 23, apparatus 2300 comprises generator unit 2302 and transmitter unit 2304. The generator unit 2302 is configured to generate the mapping between the radio bearer identifier and the logical channel identifier. The radio bearer identifier uniquely identifies the radio bearer for a sidelink communication between the transmitting wireless device and the receiving wireless device. The logical channel identifier uniquely identifies the logical channel for the sidelink communication. The transmitter unit 2304 is configured to transmit the generated mapping to the transmitting wireless device. In some implementations, the processing circuitry may be used to cause generator unit 2302, transmitter unit 2304, and any other suitable units of apparatus 2300 to perform corresponding functions according one or more embodiments of the present disclosure.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Embodiments

### Group A Embodiments

1. A method performed by a transmitting wireless device for managing sidelink communication security, the method comprising:
   generating a radio bearer identifier, wherein the generated radio bearer identifier uniquely identifies a radio bearer for a sidelink communication between the transmitting wireless device and a receiving wireless device; and—
   transmitting the generated bearer identifier to the receiving wireless device, wherein the generated bearer identifier is for use in applying a security protocol to the sidelink communication.
2. The method of embodiment 1, wherein:
   the radio bearer identifier is generated in response to initiation of the radio bearer.
3. The method of embodiment 1 or 2, wherein:
   the generated radio bearer identifier is mapped to a logical channel identifier; and
   the logical channel identifier uniquely identifies a logical channel for the sidelink communication.
4. The method of embodiment 3, further comprising the step of:
   acquiring the mapping of the generated radio bearer identifier to the logical channel identifier.
5. The method of embodiment 4, wherein:
   acquiring the mapping comprises:
   generating the mapping;
   receiving the mapping from a base station serving the transmitting wireless device; or retrieving the mapping from a memory in the transmitting wireless device.
6. The method of embodiment 5, wherein:
   the mapping is received from the base station as part of a plurality of mappings of radio bearer identities to respective logical channel identifiers; and
   the method further comprises the step of:
   selecting the mapping of the generated radio bearer identifier to the logical channel identifier from the plurality of mappings.
7. The method of embodiment 5, wherein:
   the memory comprises a plurality of mappings of radio bearer identities to respective logical channel identifiers; and the method further comprises the step of:
   selecting the mapping of the generated radio bearer identifier to the logical channel identifier from the plurality of mappings.
8. The method of any of embodiments 5 to 7, wherein:
   the memory is a subscriber identity module card.
9. The method of embodiment 5 to 8, wherein:
   the mapping is received from the base station via a request to establish the sidelink communication or via a message broadcast by the base station to the transmitting wireless device.
10. The method of any of embodiments 4 to 9, wherein:
   the mapping is acquired in response to initiation of the radio bearer.
11. The method of any of embodiments 3 to 10, further comprising the step of:
   storing, in a memory of the transmitting wireless device, the generated radio bearer identifier and the mapping.
12. The method of any of embodiments 3 to 11, further comprising the step of:
   transmitting, to the receiving wireless device, the mapping and/or a mapping identifier that uniquely identifies the mapping.
13. The method of any of embodiments 3 to 12, wherein:
   the radio bearer identifier and the logical channel identifier are of the same or different formats.
14. The method of any of embodiments 3 to 13, wherein:
   the logical channel identifier comprises 6-bits.
15. The method of any of the previous embodiments, wherein:
   the radio bearer identifier comprises 5-bits.
16. The method of any of the previous embodiments, wherein:
   transmitting the generated bearer identifier to the receiving wireless device comprises:
      transmitting, to the receiving wireless device, a request to establish the sidelink communication, wherein the request comprises the generated bearer identifier.
17. The method of any of the previous embodiments, further comprising the step of:
   applying the security protocol to the sidelink communication using the generated bearer identifier.
18. The method of any of the previous embodiments, wherein:
   applying the security protocol to the sidelink communication using the generated bearer identifier comprises:
   authenticating the sidelink communication using the generated bearer identifier; or
   encrypting the sidelink communication using the generated bearer identifier.
19. A method performed by a receiving wireless device for managing sidelink communication security, the method comprising:
   receiving a bearer identifier from a transmitting wireless device, wherein the radio bearer identifier uniquely identifies a radio bearer for a sidelink communication between the transmitting wireless device and the receiving wireless device, and wherein the bearer identifier is for use in applying a security protocol to the sidelink communication.
20. The method of embodiment 19, wherein:
   the received radio bearer identifier is mapped to a logical channel identifier; and
   the logical channel identifier uniquely identifies a logical channel for the sidelink communication.
21. The method of embodiment 20, further comprising the step of:
   acquiring the mapping of the received radio bearer identifier to the logical channel identifier.
22. The method of embodiment 21, wherein:
   acquiring the mapping comprises:
      receiving the mapping from the transmitting wireless device;
      receiving the mapping from a base station serving the receiving wireless device; or
      retrieving the mapping from a memory in the receiving wireless device.
23. The method of embodiment 22, wherein:
   the mapping is received from the transmitting wireless device or the base station as part of a plurality of mappings of radio bearer identities to respective logical channel identifiers; and
   the method further comprises the step of:
      selecting the mapping of the received radio bearer identifier to the logical channel identifier from the plurality of mappings.
24. The method of embodiment 22, wherein:
   the memory comprises a plurality of mappings of radio bearer identities to respective logical channel identifiers; and the method further comprises the step of:
      selecting the mapping of the received radio bearer identifier to the logical channel identifier from the plurality of mappings.
25. The method of embodiment 23 or 24, further comprising the step of:
   receiving, from the transmitting wireless device, a mapping identifier that uniquely identifies the mapping; and
   wherein the mapping of the received radio bearer identifier to the logical channel identifier is selected from the plurality of mappings using the received mapping identifier.
26. The method of any of embodiments 22 to 25, further comprising the step of:
   if the receiving wireless device is already configured to use a different mapping, reconfiguring the receiving wireless device to use the received mapping instead.
27. The method of any of embodiments 22 to 25, further comprising the step of:
   if the receiving wireless device is already configured to use a different mapping, rejecting the received mapping and transmitting the different mapping to the transmitting device.
28. The method of any of embodiments 22 to 25, further comprising the step of:
   if the receiving wireless device is not already configured to use a mapping, configuring the receiving wireless device to use the received mapping.
29. The method of embodiment 28, further comprising the step of:
   informing a base station serving the receiving wireless device that the receiving wireless device is configured to use the received mapping.
30. The method of any of embodiments 22 to 29, wherein:
   the memory is a subscriber identity module card.
31. The method of embodiment 22 to 30, wherein:
   the mapping is received from the base station via a request to establish the sidelink communication or via a message broadcast by the base station to the receiving wireless device.
32. The method of any of embodiments 21 to 31, wherein:
   the mapping is acquired in response to initiation of the radio bearer.
33. The method of any of embodiments 20 to 32, further comprising the step of:
   storing, in a memory of the receiving wireless device, the received radio bearer identifier and the mapping.
34. The method of any of embodiments 20 to 33, wherein:
   the radio bearer identifier and the logical channel identifier are of the same or different formats.
35. The method of any of embodiments 20 to 34, wherein:
   the logical channel identifier comprises 6-bits.
36. The method of any of embodiments 20 to 35, wherein:
   the radio bearer identifier comprises 5-bits.
37. The method of any of embodiments 20 to 36, wherein:
   receiving the bearer identifier comprises:
      receiving a request to establish the sidelink communication, wherein the request comprises the bearer identifier.
38. The method of any of embodiments 20 to 37, further comprising the step of:
   applying the security protocol to the sidelink communication using the received bearer identifier.
39. The method of any of embodiments 20 to 38, wherein:
   applying the security protocol to the sidelink communication using the received bearer identifier comprises:
      authenticating the sidelink communication using the received bearer identifier; or
      encrypting the sidelink communication using the received bearer identifier.
40. A method performed by a first wireless device for managing sidelink communication security, the method comprising:—
   selecting a first parameter and a second parameter for use in applying a security protocol to a sidelink communication between the first wireless device and a second wireless device.
41. The method of embodiment 40, wherein:
   the first parameter and second parameter are previously unused together in the application of a security protocol to a sidelink communication between the first wireless device and the second wireless device.
42. The method of embodiment 40 or 41, wherein:
   the second parameter is a cryptographic key.
43. The method of any of embodiments 40 to 42, wherein:
   the first parameter is a radio bearer identifier, wherein the radio bearer identifier uniquely identifies a radio bearer for the sidelink communication.
44. The method of embodiment 43, wherein:
   the generated radio bearer identifier is mapped to a logical channel identifier; and
   the logical channel identifier uniquely identifies a logical channel for the sidelink communication.
45. The method of embodiment 44, wherein:
   the radio bearer identifier is selected as a first of two parts of the logical channel identifier.
46. The method of embodiment 45, further comprising the step of:
   selecting a third parameter for use in applying the security protocol to the sidelink communication, wherein the third parameter is selected as a second of the two parts of the logical channel identifier.
47. The method of embodiment 46, wherein:
   the third parameter comprises one or more bits of a counter.
48. The method of embodiment 47, wherein:
   the third parameter comprises the most significant bit of the counter.
49. The method of any of embodiments 40 to 48, further comprising the step of:
   initiating a refresh procedure to refresh the second parameter such that the selected second parameter is previously unused in the application of a security protocol to a sidelink communication between the first wireless device and the second wireless device.
50. The method of embodiment 40 or 41, wherein:
   the first parameter is a first of two parts of a logical channel identifier and the second parameter is a second of the two parts of the logical channel identifier, wherein the logical channel identifier uniquely identifies a logical channel for the sidelink communication.
51. The method of embodiment 50, wherein:
   the first parameter is mapped to a radio bearer identifier, wherein the radio bearer identifier uniquely identifies a radio bearer for the sidelink communication.
52. The method of embodiment 50 or 51, wherein:
   the second parameter is mapped to one or more bits of a counter.
53. The method of embodiment 52, wherein:
   the second parameter comprises the most significant bit of the counter.
54. The method of any of embodiments 40 to 53, further comprising the step of:
   applying the security protocol to the sidelink communication using the selected first parameter and the selected second parameter.
55. The method of any of embodiments 40 to 54, wherein:
   applying the security protocol to the sidelink communication using the selected first parameter and the selected second parameter comprises:
      authenticating the sidelink communication using the selected first parameter and the selected second parameter; or
      encrypting the sidelink communication using the selected first parameter and the selected second parameter.
56. The method of any of the previous embodiments, further comprising:
   providing user data; and—
   forwarding the user data to a host computer via the transmission to the base station.

### Group B Embodiments

57. A method performed by a base station serving a transmitting wireless device for generation of a mapping between identifiers, the method comprising:
   generating a mapping between a radio bearer identifier and a logical channel identifier, wherein the radio bearer identifier uniquely identifies a radio bearer for a sidelink communication between the transmitting wireless device and a receiving wireless device, and wherein the logical channel identifier uniquely identifies a logical channel for the sidelink communication; and—
   transmitting the generated mapping to the transmitting wireless device.
58. The method of embodiment 57, wherein:
   the base station is serving the receiving wireless device; and
   the method further comprises the step of:
      transmitting the generated mapping to the receiving wireless device.
59. The method of embodiment 57, wherein:
   a different base station is serving the receiving wireless device; and
   the method further comprises the step of:
      transmitting the generated mapping to the base station serving the receiving wireless device.
60. The method of any of the previous embodiments, further comprising:
   obtaining user data; and—
   forwarding the user data to a host computer or a wireless device.

### Group C Embodiments

61. A wireless device for managing sidelink communication security, the wireless device comprising:
   processing circuitry configured to perform any of the steps of any of the Group A embodiments; and—
   power supply circuitry configured to supply power to the wireless device.
62. A base station for generation of a mapping between identifiers, the base station comprising:
   processing circuitry configured to perform any of the steps of any of the Group B embodiments;
   power supply circuitry configured to supply power to the base station.
63. A user equipment (UE) for managing sidelink communication security, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and—
   a battery connected to the processing circuitry and configured to supply power to the UE.
64. A communication system including a host computer comprising:
   processing circuitry configured to provide user data; and—
   a communication interface configured to forward the user data to a cellular network for transmission to a user equipment (UE),—
   wherein the cellular network comprises a base station having a radio interface and processing circuitry, the base station's processing circuitry configured to perform any of the steps of any of the Group B embodiments.
65. The communication system of the previous embodiment further including the base station.
66. The communication system of the previous 2 embodiments, further including the UE, wherein the UE is configured to communicate with the base station.
67. The communication system of the previous 3 embodiments, wherein:
   the processing circuitry of the host computer is configured to execute a host application, thereby providing the user data; and—
   the UE comprises processing circuitry configured to execute a client application associated with the host application.
68. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
69. The method of the previous embodiment, further comprising, at the base station, transmitting the user data.
70. The method of the previous 2 embodiments, wherein the user data is provided at the host computer by executing a host application, the method further comprising, at the UE, executing a client application associated with the host application.
71. A user equipment (UE) configured to communicate with a base station, the UE comprising a radio interface and processing circuitry configured to performs the of the previous 3 embodiments.
72. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
73. The communication system of the previous embodiment, wherein the cellular network further includes a base station configured to communicate with the UE.
74. The communication system of the previous 2 embodiments, wherein:
   the processing circuitry of the host computer is configured to execute a host application, thereby providing the user data; and
   the UE's processing circuitry is configured to execute a client application associated with the host application.
75. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
76. The method of the previous embodiment, further comprising at the UE, receiving the user data from the base station.
77. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
78. The communication system of the previous embodiment, further including the UE.
79. The communication system of the previous 2 embodiments, further including the base station, wherein the base station comprises a radio interface configured to communicate with the UE and a communication interface configured to forward to the host computer the user data carried by a transmission from the UE to the base station.
80. The communication system of the previous 3 embodiments, wherein:
   the processing circuitry of the host computer is configured to execute a host application; and
   the UE's processing circuitry is configured to execute a client application associated with the host application, thereby providing the user data.
81. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
82. A method implemented in a communication system including a host computer, a base station and a user equipment (UE), the method comprising:
   at the host computer, receiving user data transmitted to the base station from the UE, wherein the UE performs any of the steps of any of the Group A embodiments.
83. The method of the previous embodiment, further comprising, at the UE, providing the user data to the base station.
84. The method of the previous 2 embodiments, further comprising:
   at the UE, executing a client application, thereby providing the user data to be transmitted; and
   at the host computer, executing a host application associated with the client application.
85. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
86. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
87. The communication system of the previous embodiment further including the base station.
88. The communication system of the previous 2 embodiments, further including the UE, wherein the UE is configured to communicate with the base station.
89. The communication system of the previous 3 embodiments, wherein:
   the processing circuitry of the host computer is configured to execute a host application;
   the UE is configured to execute a client application associated with the host application, thereby providing the user data to be received by the host computer.
90. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
91. The method of the previous embodiment, further comprising at the base station, receiving the user data from the UE.
92. The method of the previous 2 embodiments, further comprising at the base station, initiating a transmission of the received user data to the host computer.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network
BSR Buffer status report
CSI Channel state information
D2D Device to device
DCI Downlink control channel
ID Identifier
LCP Logical channel prioritization
MAC CE Medium Access Control Element
MCS Modulation and Coding Scheme
NW Network
ProSe Proximity services
RS Reference signal
RRC Radio resource control
SL Sidelink
SPS Semi-persistent Scheduling
SR Scheduling request
UE User equipment
V2I Vehicle-to-infrastructure
V2N Vehicle-to-network
V2V Vehicle-to-vehicle
V2P Vehicle-to-pedestrian
V2X Vehicle-to-anything communication

1-40. (canceled)

41. A method performed by a transmitting wireless device for managing sidelink communication security, the method comprising:
generating a radio bearer identifier, wherein the generated radio bearer identifier uniquely identifies a radio bearer for a sidelink communication between the transmitting wireless device and a receiving wireless device; and
transmitting the generated radio bearer identifier to the receiving wireless device, wherein the generated radio bearer identifier is for use in applying a security protocol to the sidelink communication.

42. The method of claim 41, wherein the generated radio bearer identifier is generated in response to initiation of the radio bearer.

43. The method of claim 41, wherein the generated radio bearer identifier is mapped to a logical channel identifier that uniquely identifies a logical channel for the sidelink communication.

44. The method of claim 43, wherein the method further comprises one of: generating the mapping, determining the mapping from information stored in a memory of the transmitting wireless device, or determining the mapping from information received from a base station serving the transmitting wireless device.

45. The method of claim 43, wherein information stored or received in the wireless device defines a plurality of mappings of radio bearer identities to respective logical channel identifiers, and wherein the method further comprises selecting, from the plurality of mappings, the mapping of the generated radio bearer identifier to the logical channel identifier.

46. The method of claim 41, further comprising transmitting, to the receiving wireless device, a request to establish the sidelink communication, wherein the request comprises the generated radio bearer identifier.

47. The method of claim 41, further comprising applying the security protocol to the sidelink communication using the generated radio bearer identifier, wherein applying the security protocol comprises authenticating the sidelink communication using the generated radio bearer identifier or encrypting the sidelink communication using the generated radio bearer identifier.

48. A method performed by a receiving wireless device for managing sidelink communication security, the method comprising:
receiving a radio bearer identifier from a transmitting wireless device, wherein the radio bearer identifier uniquely identifies a radio bearer for a sidelink communication between the transmitting wireless device and the receiving wireless device, and wherein the radio bearer identifier is for use in applying a security protocol to the sidelink communication.

49. The method of claim 48, wherein the received radio bearer identifier is mapped to a logical channel identifier and the logical channel identifier uniquely identifies a logical channel for the sidelink communication.

50. The method of claim 49, further comprising one of: receiving the mapping from a base station serving the receiving wireless device, receiving the mapping from the transmitting wireless device, or retrieving the mapping from a memory of the receiving wireless device.

51. The method of claim 49, further comprising determining the mapping from a plurality of mappings of radio bearer identities to respective logical channel identifiers.

52. The method of claim 51, further comprising obtaining information indicating the plurality of mappings from one of: the transmitting wireless device, a base station serving the receiving wireless device, or a memory of the receiving wireless device.

53. The method of claim 51, further comprising receiving a mapping identifier from the transmitting wireless device, and using the mapping identifier to select, from the plurality of mappings, the mapping of the radio bearer identity.

54. The method of claim 49, wherein the mapping is configured at the receiving wireless device and, responsive to receiving an indication of a different mapping to use for the radio bearer identity, either reconfiguring the receiving wireless device to use the different mapping or rejecting the different mapping and transmitting an indication of the configured mapping to the transmitting wireless device.

55. The method of claim 54, further comprising informing a base station serving the receiving wireless device of the reconfiguration.

56. The method of claim 48, wherein receiving the radio bearer identifier comprises receiving a request to establish the sidelink communication, wherein the request comprises the radio bearer identifier.

57. The method of claim 48, further comprising applying the security protocol to the sidelink communication using the received radio bearer identifier, wherein applying the security protocol comprises authenticating the sidelink communication using the received radio bearer identifier or encrypting the sidelink communication using the received radio bearer identifier.

58. A wireless device for managing sidelink communication security, the wireless device comprising:
communication circuitry configured for transmission and reception of wireless signals; and
processing circuitry configured to:
generate a radio bearer identifier, wherein the generated radio bearer identifier uniquely identifies a radio bearer for a sidelink communication between the transmitting wireless device and a receiving wireless device; and
transmit, via the communication circuitry, the generated radio bearer identifier to the receiving wireless device, wherein the generated radio bearer identifier is for use in applying a security protocol to the sidelink communication.

59. A method performed by a base station serving a transmitting wireless device for generation of a mapping between identifiers, the method comprising:
generating a mapping between a radio bearer identifier and a logical channel identifier, wherein the radio bearer identifier uniquely identifies a radio bearer for a sidelink communication between the transmitting wireless device and a receiving wireless device, and wherein the logical channel identifier uniquely identifies a logical channel for the sidelink communication; and
transmitting the generated mapping to the transmitting wireless device.

60. The method of claim 59, wherein the base station is serving the receiving wireless device and the method further comprises transmitting the generated mapping to the receiving wireless device, or wherein a different base station is serving the receiving wireless device and the method further comprises transmitting the generated mapping to the base station serving the receiving wireless device.
